(19) United States
(12) Patent Application Publication
(10) Pub. No.: US 2006/0039254 A1
(43) Pub. Date: Feb. 23, 2006

(54) Recording and reproduction apparatus and method, program, and recording medium

(75) Inventor: Tsutomu Hirasawa, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/203,507

(22) Filed: Aug. 15, 2005

(30) Foreign Application Priority Data
Aug. 20, 2004 (JP) 2004-241276

(51) Int. Cl. H04H 9/00; G11B 19/02

(52) U.S. Cl. 369/47.1; 369/7; 369/53.1

(57) ABSTRACT

A recording and reproduction apparatus and method is disclosed by which the copyright of a content can be protected appropriately and the convenience to a user can be enhanced. When a content stored on a first disk is to be copied on a second disk, the apparatus identifies a first, secure content encrypted by a predetermined method and a second, non-secure content from each other. Then, the apparatus copies only the non-secure content into an auxiliary memory and stores IDs of the second content and the first disk in a coordinated relationship. If a user unloads the first disk from the apparatus and loads the new second disk, then the apparatus decides whether or not the new disk is different from the first disk. If the new disk is different, then the content is copied from the auxiliary memory on the second disk.

### BACKGROUND OF THE INVENTION

This invention relates to a recording and reproduction apparatus and method, a program, and a recording medium, and more particularly a recording and reproduction apparatus and method, a program, and a recording medium which are suitable for protection of the copyright of a content and for improvement of user's convenience.

In recent years, a method has been popularized which makes use of a music distribution service or the like to download tune data to acquire a desired tune without purchasing CD (Compact Disk) or the like. In a popular music distribution service, a user in most cases downloads desired tune data from among tune data accumulated in a server into a personal computer of the user through a network paying an equivalent. Since tune data distributed by the music distribution service are digital data and can themselves be duplicated easily, tune data to be distributed often have a form wherein they are encrypted by a predetermined method in order to protect the copyright of the tune data. In this instance, in order to reproduce downloaded tune data, a key for decrypting the encrypted data is required.

In order to consolidate the system for copyright protection of such digital data, a system for limiting copying or movement of a content based on identification information of a transfer source of the content has been proposed. One of such systems is disclosed, for example, in Japanese Patent Laid-Open No. 2001-125833 (hereinafter referred to as Patent Document 1).

Also a system which produces management information for coordinating contents and identification information for specifying the contents with each other to manage duplication of the contents has been proposed. One of such systems is disclosed, for example, in Japanese Patent Laid-Open No. 2003-280993 (hereinafter referred to as Patent Document 2)

However, a user has high needs to enjoy a content such as tune data taken in a personal computer making use of a portable device (PD) which can be carried by the user. In this instance, the user reproduces the tune data on the personal computer and records the reproduced tune data on a medium which can be recorded/reproduced by the portable device. Usually, however, data to be recorded on the medium by the portable device is not limited to tune data acquired by a music distribution service but includes some other tune data or the like recorded by the user. According to the related art, it cannot be identified whether or not tune data recorded on a medium of a portable device is a content which is an object of copyright protection. As a result, there is a subject to be solved in that the copyright of a content which is an object of copyright protection cannot be protected appropriately.

Further, according to the related art, the user itself must manage regarding on which medium a predetermined content is recorded. Thus, when a content is copied simply from a medium on which the content is recorded to another medium, there is the possibility that the content may be copied on the same medium. Therefore, there is a subject to be solved also in that much time is required for management of contents to the user.

### SUMMARY OF THE INVENTION

According to the present invention, it is desirable to provide a recording and reproduction apparatus and method, a program, and a recording medium by which the copyright of a content can be protected appropriately and the convenience to a user can be enhanced.

In order to attain the object described above, according an embodiment of the present invention, there is provided a recording and reproduction apparatus for recording data of a content on a disk and reproducing data of a content recorded on the disk, including a first disk specification information acquisition section for acquiring information which specifies a disk loaded in the recording and reproduction apparatus, a content specification information acquisition section for acquiring information which specifies a content recorded on the disk, a table production section for producing a table which coordinates the information, which specifies the disk, acquired by the first disk specification information acquisition section and the information, which specifies the content, acquired by the content specification information acquisition section, a storage section for storing the content into a memory, a disk loading decision section for deciding whether or not a disk is newly loaded in the recording and reproduction apparatus, a second disk specification information acquisition section for acquiring, when it is decided by the disk loading decision section that a disk is newly loaded, information which specifies the newly loaded disk, and a content copying section for copying the content stored in the storage section on the newly loaded disk or restraining such copying based on the table and the information acquired by the second disk specification information acquisition section and specifying the newly loaded disk.

According to another embodiment of the present invention, there is provided a recording and reproduction method for a recording and reproduction apparatus for recording data of a content on a disk and reproducing data of a content recorded on the disk, including a first disk specification information acquisition step of acquiring information which specifies a disk loaded in the recording and reproduction apparatus, a content specification information acquisition step of acquiring information which specifies a content recorded on the disk, a table production step of producing a table which coordinates the information, which specifies the disk, acquired by the process at the first disk specification information acquisition step and the information, which specifies the content, acquired by the process at the content specification information acquisition step, a storage step of storing the content into a memory, a disk loading decision step of deciding whether or not a disk is newly loaded in the recording and reproduction apparatus, a second disk specification information acquisition step of acquiring, when it is decided by the process at the disk loading decision step that a disk is newly loaded, information which specifies the newly loaded disk, and a content copying step of copying the content stored by the process at the storage step on the newly loaded disk or restraining such copying based on the table and the information acquired by the process at the second disk specification information acquisition step and specifying the newly loaded disk.

According to a further embodiment of the present invention, there is provided a program for a recording and reproduction apparatus for recording data of a content on a disk and reproducing data of a content recorded on the disk, including a first disk specification information acquisition controlling step of controlling acquisition of information which specifies a disk loaded in the recording and reproduction apparatus, a content specification information acquisition controlling step of controlling acquisition of information which specifies a content recorded on the disk, a table production controlling step of controlling production of a table which coordinates the information, which specifies the disk, acquired by the process at the first disk specification information acquisition controlling step and the information, which specifies the content, acquired by the process at the content specification information acquisition controlling step, a storage controlling step of controlling storage of the content into a memory, a disk loading decision controlling step of controlling decision of whether or not a disk is newly loaded in the recording and reproduction apparatus, a second disk specification information acquisition controlling step of controlling acquisition, when it is decided by the process at the disk loading decision controlling step that a disk is newly loaded, information which specifies the newly loaded disk, and a content copying controlling step of controlling so as to copy the content stored by the process at the storage step on the newly loaded disk or restrain such copying based on the table and the information acquired by the process at the second disk specification information acquisition step and specifying the newly loaded disk.

According to a still further embodiment of the present invention, there is provided a recording medium on which a program for a recording and reproduction apparatus for recording data of a content on a disk and reproducing data of a content recorded on the disk is recorded, the program including a first disk specification information acquisition controlling step of controlling acquisition of information which specifies a disk loaded in the recording and reproduction apparatus, a content specification information acquisition controlling step of controlling acquisition of information which specifies a content recorded on the disk, a table production controlling step of controlling production of a table which coordinates the information, which specifies the disk, acquired by the process at the first disk specification information acquisition controlling step and the information, which specifies the content, acquired by the process at the content specification information acquisition controlling step, a storage controlling step of controlling storage of the content into a memory, a disk loading decision controlling step of controlling decision of whether or not a disk is newly loaded in the recording and reproduction apparatus, a second disk specification information acquisition controlling step of controlling acquisition, when it is decided by the process at the disk loading decision controlling step that a disk is newly loaded, information which specifies the newly loaded disk, and a content copying controlling step of controlling so as to copy the content stored by the process at the storage step on the newly loaded disk or restrain such copying based on the table and the information acquired by the process at the second disk specification information acquisition step and specifying the newly loaded disk.

In the recording and reproduction apparatus and method, program and recording medium, information which specifies a disk loaded in the recording and reproduction apparatus is acquired, and information which specifies a content recorded on the disk is acquired. Then, a table which coordinates the information which specifies the disk and the information which specifies the content is produced. Then, the content is stored into a memory, and it is decided whether or not a disk is newly loaded in the recording and reproduction apparatus. When it is decided that a disk is newly loaded, information which specifies the newly loaded disk is acquired. Further, the content stored is copied on the newly loaded disk or such copying is restrained based on the table and the information specifying the newly loaded disk.

With the recording and reproduction apparatus and method, program and recording medium, the copyright of a content can be protected appropriately and the convenience for a user can be enhanced.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic block diagram showing an example of a content management system to which the present invention is applied;

FIG. 2 is a diagrammatic view illustrating an example of storing states of a content in various apparatus shown in FIG. 1;

FIG. 3 is a diagrammatic view illustrating an example of a content moved or copied between different disks;

FIG. 4 is a schematic view showing a configuration of a disk of the next generation MD1;

FIG. 5 is a diagrammatic view showing a configuration of a recordable region of the disk shown in FIG. 4;

FIG. 6 is a schematic view showing a configuration of a disk of the next generation MD2;

FIG. 7 is a diagrammatic view showing a configuration of a recordable region of the disk of FIG. 6;

FIG. 8 is a diagrammatic view illustrating an example of a format of a UID;

FIG. 9 is a block diagram showing an example of a configuration of a recording and reproduction apparatus according to the present invention;

FIG. 10 is a diagrammatic view illustrating an example of a first management method of audio data;

FIG. 11 is a diagrammatic view illustrating an example of a configuration of an audio data file shown in FIG. 10;

FIG. 12 is a diagrammatic view illustrating an example of a configuration of a track index file shown in FIG. 10;

FIG. 13 is a diagrammatic view illustrating an example of a configuration of a play order table shown in FIG. 12;

FIG. 14 is a diagrammatic view illustrating an example of a configuration of a programmed play order table shown in FIG. 12;

FIG. 15 is a diagrammatic view illustrating an example of a configuration of a group information table shown in FIG. 12;

FIG. 16 is a diagrammatic view illustrating an example of a configuration of a group descriptor shown in FIG. 15;

FIG. 17 is a diagrammatic view illustrating an example of a configuration of a track information table shown in FIG. 12;

FIG. 18 is a diagrammatic view illustrating an example of a configuration of a track descriptor shown in FIG. 17;

FIG. 19 is a diagrammatic view illustrating an example of a configuration of a part information table shown in FIG. 12;

FIG. 20 is a diagrammatic view illustrating an example of a configuration of a part descriptor shown in FIG. 19;

FIG. 21 is a diagrammatic view illustrating an example of a configuration of a name table shown in FIG. 12;

FIG. 22 is a diagrammatic view illustrating an example of a configuration of a name slot shown in FIG. 21;

FIG. 23 is a diagrammatic view illustrating an example of reproduction of audio data according to the first management method;

FIG. 24 is a view illustrating an example of a second management method of audio data;

FIG. 25 is a diagrammatic view illustrating an example of a configuration of an audio data file shown in FIG. 24;

FIG. 26 is a diagrammatic view illustrating an example of a configuration of a track index file shown in FIG. 24;

FIG. 27 is a diagrammatic view illustrating an example of a configuration of a play order table shown in FIG. 26;

FIG. 28 is a diagrammatic view illustrating an example of a configuration of a programmed play order table shown in FIG. 26;

FIG. 29 is a diagrammatic view illustrating an example of a configuration of a group information table shown in FIG. 26;

FIG. 30 is a diagrammatic view illustrating an example of a configuration of a group descriptor shown in FIG. 29;

FIG. 31 is a diagrammatic view illustrating an example of a configuration of a track information table shown in FIG. 26;

FIG. 32 is a diagrammatic view illustrating an example of a configuration of a track descriptor shown in FIG. 31;

FIG. 33 is a diagrammatic view illustrating an example of a configuration of a name table shown in FIG. 26;

FIG. 34 is a diagrammatic view illustrating an example of a configuration of a name slot shown in FIG. 33;

FIG. 35 is a diagrammatic view illustrating an example of reproduction of audio data according to the second management method;

FIG. 36 is a block diagram showing an example of a functional configuration of software executed by a system controller shown in FIG. 9;

FIG. 37 is a flow chart illustrating a content moving process executed by the system controller shown in FIG. 9;

FIG. 38 is a flow chart illustrating a content type dependent process executed by the system controller shown in FIG. 9;

FIG. 39 is a diagrammatic view illustrating an example of a content copied between a disk and an auxiliary memory;

FIGS. 40 and 41 are flow charts illustrating a data copying process executed by the system controller shown in FIG. 9;

FIG. 42 is a diagrammatic view illustrating an example of a table for coordinating content IDs and UIDs of disks with each other; and

FIG. 43 is a block diagram showing an example of a configuration of a computer.

### DETAILED DESCRIPTION OF THE PREFERRED EMBODIMENTS

Before a preferred embodiment of the present invention is described in detail, a corresponding relationship between several features recited in the accompanying claims and particular elements of the preferred embodiment described below is described. The description, however, is merely for the confirmation that the particular elements which support the invention as recited in the claims are disclosed in the description of the embodiment of the present invention. Accordingly, even if some particular element which is recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

Further, the following description does not signify that the prevent invention corresponding to particular elements described in the embodiment of the present invention is all described in the claims. In other words, the following description does not deny the presence of an invention which corresponds to a particular element described in the description of the embodiment of the present invention but is not recited in the claims, that is, the description does not deny the presence of an invention which may be filed for patent in a divisional patent application or may be additionally included into the present patent application as a result of later amendment to the claims.

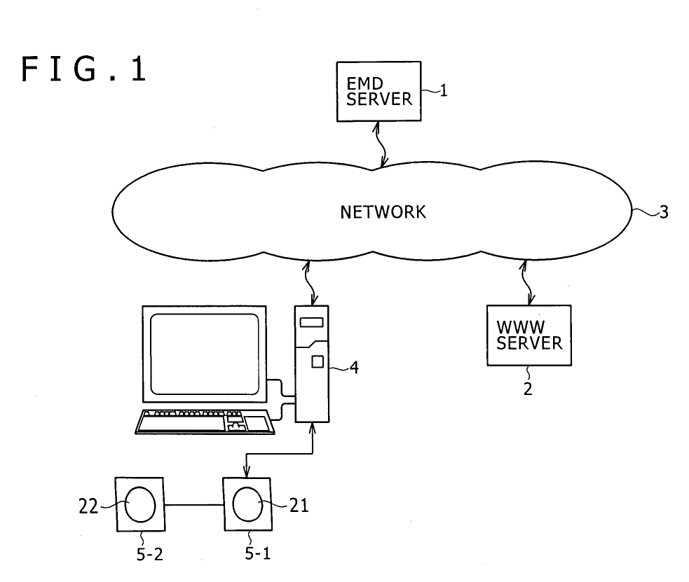

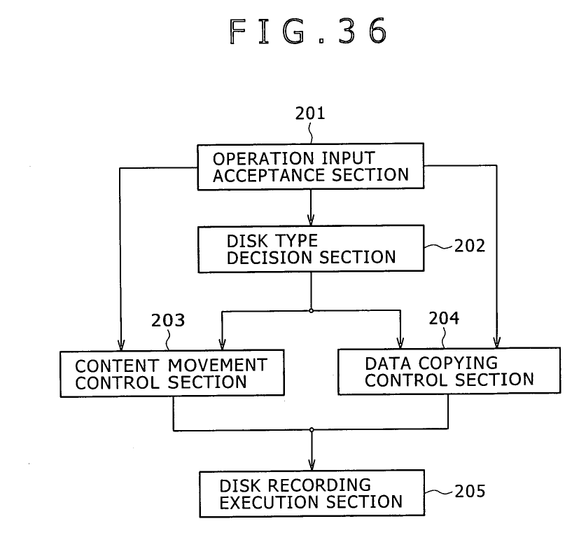

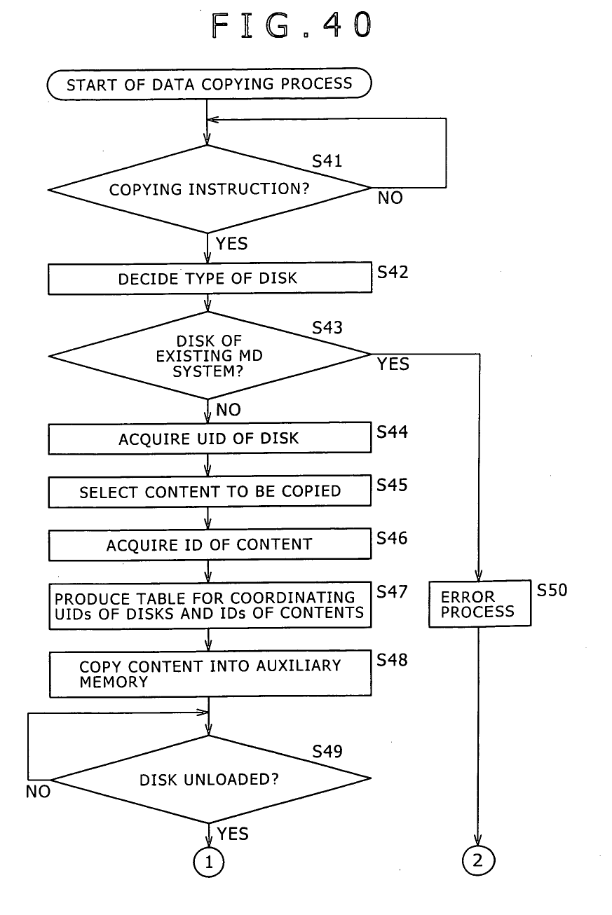

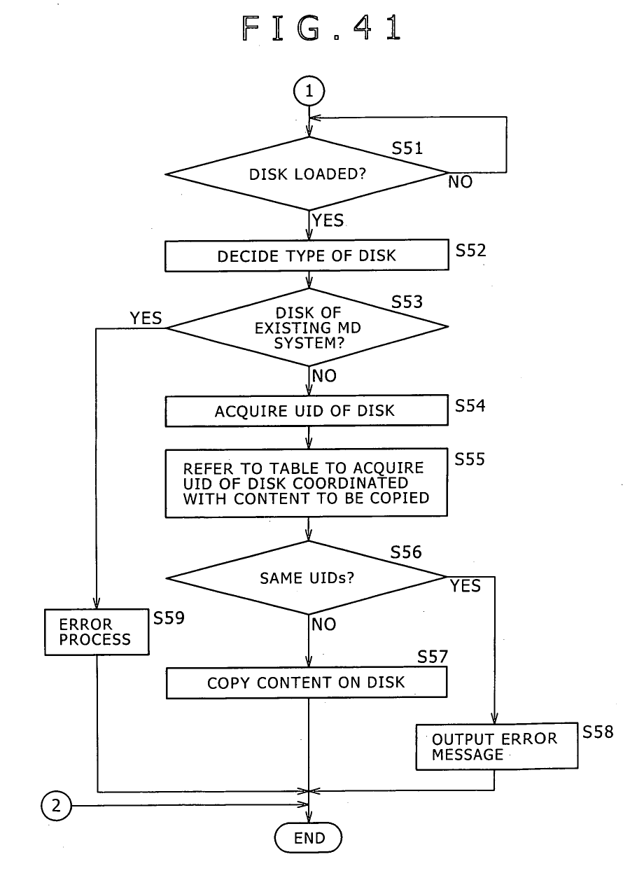

According to the invention as set forth in claim 1, there is provided a recording and reproduction apparatus (for example, a recording and reproduction apparatus 5-1 or 5-2 of FIG. 1) for recording data of a content on a disk (for example, a disk 21 or 22 of FIG. 1) and reproducing data of a content recorded on the disk, including a first disk specification information acquisition section (for example, a data copying control section 204 of FIG. 36 which executes a process at step S44 of FIG. 40) for acquiring information which specifies a disk loaded in the recording and reproduction apparatus, a content specification information acquisition section (for example, the data copying control section 204 of FIG. 36 which executes a process at step S46 of FIG. 40) for acquiring information which specifies a content recorded on the disk, a table production section (for example, the data copying control section 204 of FIG. 36 which executes a process at step S47 of FIG. 40) for producing a table which coordinates the information, which specifies the disk, acquired by the first disk specification information acquisition section and the information, which specifies the content, acquired by the content specification information acquisition section, a storage section (for example, the data copying control section 204 of FIG. 36 which executes a process at step S48 of FIG. 40) for storing the content into a memory, a disk loading decision section (for example, the data copying control section 204 of FIG. 36 which executes a process at step S51 of FIG. 41) for deciding whether or not a disk is newly loaded in the recording and reproduction apparatus, a second disk specification information acquisition section (for example, the data copying control section 204 of FIG. 36 which executes a process at step S54 of FIG. 41) for acquiring, when it is decided by the disk loading decision section that a disk is newly loaded, information which specifies the newly loaded disk, and a content copying section (for example, the data copying control section 204 of FIG. 36 which executes the process at step S57 or S58 of FIG. 41) for copying the content stored in the storage section on the newly loaded disk or restraining such copying based on the table and the information acquired by the second disk specification information acquisition section and specifying the newly loaded disk.

According to the invention as set forth in claim 2, the content copying section may copy the content on the newly loaded disk when the information acquired by the second disk specification information acquisition section and specifying the newly added disk is different from the information specifying the disk and coordinated with the information which specifies the content in the table (for example, when it is decided by the process at step S56 of FIG. 41 that the UIDs are not same as each other).

According to the invention as set forth in claim 3, the recording and reproduction apparatus may further include a disk type decision section (for example, the data copying control section 204 which executes the process at step S42 of FIG. 40 or at step S52 of FIG. 41) for deciding a type of the disk, the storage section or the content copying section storing or copying the content if it is decided by the disk type decision section that the disk is a disk of a type determined in advance.

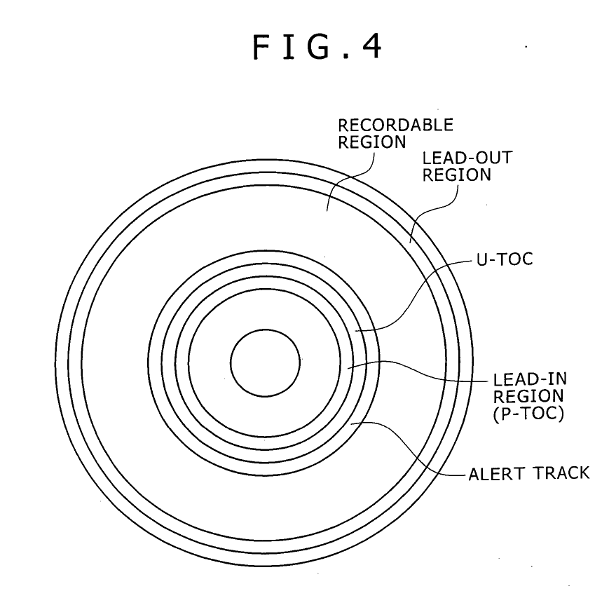

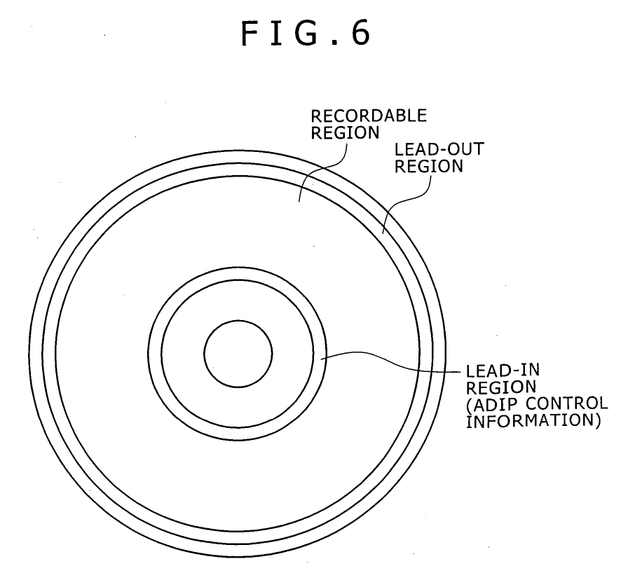

According to the invention as set forth in claim 4, in the recording and reproduction apparatus, the type of the disk may one of at least a first disk (for example, a disk of an existing MD system), a second disk (for example, a disk of the next generation MD1 of FIG. 4) having a physical attribute same as that of the first disk but having a logical attribute (for example, a format for recording and reproduction) different from that of the first disk, the second disk being suitable for recording of a secure content encrypted in accordance with a method determined in advance, and a third disk (for example, a disk of the next generation MD2 of FIG. 6) having an outer shape similar to that of the first disk but having an increased recording density so as to have an increased recording capacity when compared with the first disk, the third disk being suitable for recording of the secure content.

According to the invention as set forth in claim 5, in the recording and reproduction apparatus, the disk type decision section decides that the disk is of the type determined in advance if the disk is the second disk (for example, a disk of the next generation MD1) or the third disk (for example, a disk of the next generation MD2).

According to the invention as set forth in claim 6, the recording and reproduction apparatus further includes a content selection section (for example, the data copying control section 204 of FIG. 36 which executes a process at step S45 of FIG. 40) for selecting from among contents recorded on the disk. Those contents are not the secure content. The storage section stores the contents selected by the content selection section into the memory.

According to the invention as set forth in claim 7, there is provided a recording and reproduction method for a recording and reproduction apparatus (for example, a recording and reproduction apparatus 5-1 or 5-2) for recording data of a content on a disk (for example, a disk 21 or 22 of FIG. 1) and reproducing data of a content recorded on the disk, including a first disk specification information acquisition step (for example, a process at step S44 of FIG. 40) of acquiring information which specifies a disk loaded in the recording and reproduction apparatus, a content specification information acquisition step (for example, a process at step S46 of FIG. 40) of acquiring information which specifies a content recorded on the disk, a table production step (for example, a process at step S47 of FIG. 40) of producing a table which coordinates the information, which specifies the disk, acquired by the process at the first disk specification information acquisition step and the information, which specifies the content, acquired by the process at the content specification information acquisition step, a storage step (for example, a process at step S48 of FIG. 40) of storing the content into a memory, a disk loading decision step (for example, a process at step S51 of FIG. 41) of deciding whether or not a disk is newly loaded in the recording and reproduction apparatus, a second disk specification information acquisition step (for example, a process at step S54 of FIG. 41) of acquiring, when it is decided by the process at the disk loading decision step that a disk is newly loaded, information which specifies the newly loaded disk, and a content copying step (for example, a process at step S57 or S58 of FIG. 41) of copying the content stored by the process at the storage step on the newly loaded disk or restraining such copying based on the table and the information acquired by the process at the second disk specification information acquisition step and specifying the newly loaded disk.

According to the invention as set forth in claim 8, a program for a recording and reproduction apparatus (for example, a recording and reproduction apparatus 5-1 or 5-2 of FIG. 1) for recording data of a content on a disk (for example, a disk 21 or 22 of FIG. 1) and reproducing data of a content recorded on the disk, including a first disk specification information acquisition controlling step (for example, a process at step S44 of FIG. 40) of controlling acquisition of information which specifies a disk loaded in the recording and reproduction apparatus, a content specification information acquisition controlling step (for example, a process at step S46 of FIG. 40) of controlling acquisition of information which specifies a content recorded on the disk, a table production controlling step (for example, a process at step S47 of FIG. 40) of controlling production of a table which coordinates the information, which specifies the disk, acquired by the process at the first disk specification information acquisition controlling step and the information, which specifies the content, acquired by the process at the content specification information acquisition controlling step, a storage controlling step (for example, a process at step S48 of FIG. 40) of controlling storage of the content into a memory, a disk loading decision controlling step (for example, a process at step S51 of FIG. 41) of controlling decision of whether or not a disk is newly loaded in the recording and reproduction apparatus, a second disk specification information acquisition controlling step (for example, a process at step S54 of FIG. 41) of controlling acquisition, when it is decided by the process at the disk loading decision controlling step that a disk is newly loaded, information which specifies the newly loaded disk, and a content copying controlling step (for example, a process at step S57 or S58 of FIG. 41) of controlling so as to copy the content stored by the process at the storage step on the newly loaded disk or restrain such copying based on the table and the information acquired by the process at the second disk specification information acquisition step and specifying the newly loaded disk.

According to the invention as set forth in claim 9, there is provided a recording medium on which a program for a recording and reproduction apparatus (for example, a recording and reproduction apparatus 5-1 or 5-2 of FIG. 1) for recording data of a content on a disk (for example, a disk 21 or 22 of FIG. 1) and reproducing data of a content recorded on the disk is recorded, the program including a first disk specification information acquisition controlling step (for example, a process at step S44 of FIG. 40) of controlling acquisition of information which specifies a disk loaded in the recording and reproduction apparatus, a content specification information acquisition controlling step (for example, a process at step S46 of FIG. 40) of controlling acquisition of information which specifies a content recorded on the disk, a table production controlling step (for example, a process at step S47 of FIG. 40) of controlling production of a table which coordinates the information, which specifies the disk, acquired by the process at the first disk specification information acquisition controlling step and the information, which specifies the content, acquired by the process at the content specification information acquisition controlling step, a storage controlling step (for example, a process at step S48 of FIG. 40) of controlling storage of the content into a memory, a disk loading decision controlling step (for example, a process at step S51 of FIG. 41) of controlling decision of whether or not a disk is newly loaded in the recording and reproduction apparatus, a second disk specification information acquisition controlling step (for example, a process at step S54 of FIG. 41) of controlling acquisition, when it is decided by the process at the disk loading decision controlling step that a disk is newly loaded, information which specifies the newly loaded disk, and a content copying controlling step (for example, a process at step S57 or S58 of FIG. 41) of controlling so as to copy the content stored by the process at the storage step on the newly loaded disk or restrain such copying based on the table and the information acquired by the process at the second disk specification information acquisition step and specifying the newly loaded disk.

In the following, a preferred embodiment of the present invention is described with reference to the accompanying drawings. Referring first to FIG. 1, there is shown a content management system to which the present invention is applied. The content management system shown includes a personal computer 4 connected to a network 3 which may be a local area network, the Internet or the like. The personal computer 4 either records data (hereinafter referred to as content) of a tune received from an EMD (Electrical Music Distribution) server 1 or read from a CD (Compact Disk) as they are or converts the data into those of a predetermined coding system (for example, ATRAC3plus (trademark)) and encrypts the data in accordance with an encryption system such as the DES (Data Encryption Standard) and then records the encrypted data.

The personal computer 4 records right information representative of a utilization condition (for example, a number of times by which copying is permitted) of the content corresponding to the content recorded in the form of a plaintext or encrypted data.

The personal computer 4 stores a content recorded in an encrypted form therein together with data relating to the content (for example, the title of a tune, a reproduction condition and so forth) into a recording and reproduction apparatus 5-1 or 5-2 connected thereto through a USB (Universal Serial Bus) cable or the like. Further, in response to the storage into the recording and reproduction apparatus 5-1 or 5-2, the personal computer 4 updates the right information corresponding to the content stored therein. For example, when a content is copied and stored into the recording and reproduction apparatus 5-1 or 5-2, the permissible number of copying the right information corresponding to the stored content is decremented by one. If the permissible number of copying decreases to 0, then the corresponding content cannot be copied into the recording and reproduction apparatus 5-1 or 5-2.

The EMD server 1 supplies a content together with data (for example, the title of a tune or the like) relating to the content to the personal computer 4 through the network 3 in accordance with a request from the personal computer 4.

The content supplied by the EMD server 1 is in a form encoded in accordance with a predetermined coding system or encrypted in accordance with a predetermined encryption system in order to protect the copyright of the content. The EMD server 1 supplies a key for decoding or decrypting the content to the personal computer 4 together with the content.

A WWW (World Wide Web) server 2 supplies data of an image, text data or the like to the personal computer 4 through the network 3 in accordance with a request from the personal computer 4.

The recording and reproduction apparatus 5-1 or 5-2 communicates with the personal computer 4 connected thereto by a USB cable to store a content on a disk 21 or 22 hereinafter described loaded as a recording medium in the personal computer 4. Further, the recording and reproduction apparatus 5-1 reproduces a content stored on the disk 21 or 22 in accordance with an instruction of the user.

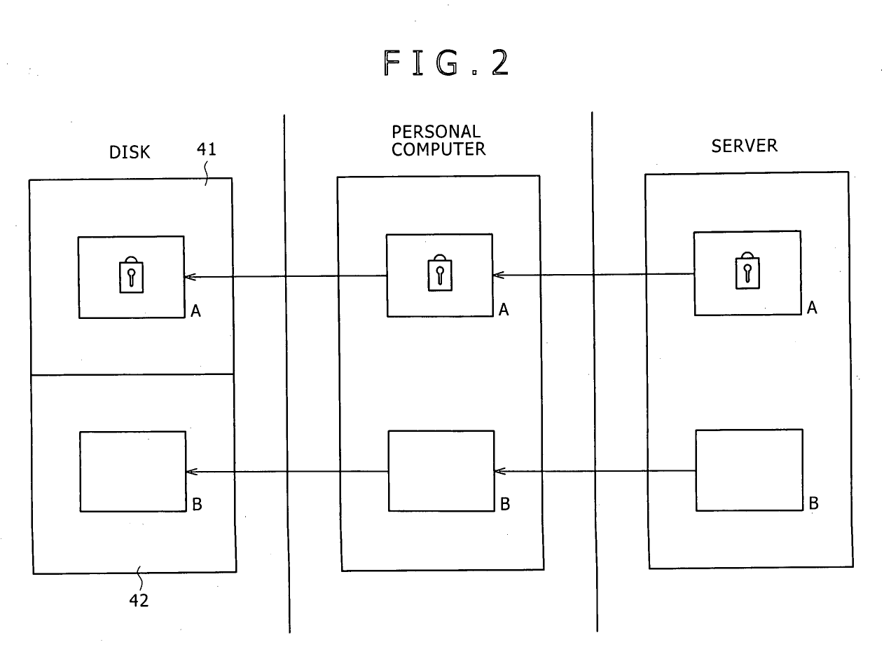

FIG. 2 illustrates an example of a storage state of contents in the apparatus shown in FIG. 1. Referring to FIG. 2, as examples of a content stored in a server, there are illustrated a content A of a tune or the like supplied, for example, from the EMD server 1 to the personal computer 4 and a content B supplied, for example, from the WWW server 2 to the personal computer 4. As described hereinabove, a content supplied from the EMD server 1 is in a form encrypted in accordance with the predetermined encryption system in order to protect the copyright of the content. In the present specification, a content encrypted in accordance with the predetermined encryption system in order to protect the copyright is referred to as secure content and is shown in such a manner as seen from the content A in FIG. 2. On the other hand, it is assumed that the content B is a content which does not have the copyright or a like and is not in an encrypted form (remains in the form of a plaintext), different from the content A.

In the personal computer 4, the content A is stored also as an encrypted secure content while the content B remains stored in the form of a plaintext on a storage section such as a hard disk drive (HDD) of the personal computer 4.

When a content is to be stored, the recording and reproduction apparatus 5-1 decides whether or not the content is a secure content, and if the content is a secure content, then it is stored into a secure region 41 of the disk 21. However, if the content is not a secure content (the content is hereinafter referred as non-secure content), then it is stored into a non-secure region 42 of the disk 21. Accordingly, on the disk 21, the content A is stored as an encrypted secure content in the secure region 41 while the content B is stored as a non-secure content while it remains in the form of a plaintext. It is to be noted that the secure region 41 and the non-secure region 42 are virtual regions in the disk for managing each of recorded contents in accordance with the type of the content, but do not have, for example, predetermined storage capacities allocated thereto.

Also the recording and reproduction apparatus 5-2 stores the content A or content B similarly to the recording and reproduction apparatus 5-1.

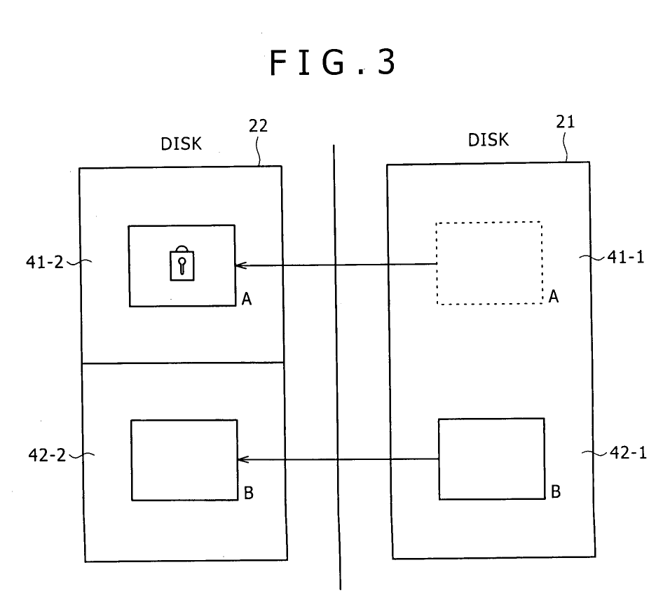

Also it is possible to connect the recording and reproduction apparatus 5-1 and 5-2 to each other such that a content is moved or copied from the disk 21 to the disk 22. In this instance, as seen in FIG. 3, the content A is moved from the secure region 41-1 of the disk 21 to the secure region 41-2 of the disk 22, and the content B is copied or moved from the non-secure region 42-1 of the disk 21 to the non-secure region 42-2 of the disk 22.

The recording and reproduction apparatus 5-1 or 5-2 does not permit copying of a secure content into another apparatus (recording medium) in order to protect the copyright and thereby prevents duplicates of a content having the copyright from being produced without limitation. Accordingly, if the content A is moved to the disk 22, then it is erased from the disk 21. On the other hand, the content B having no copyright can be copied by production of a duplicate thereof on the disk 22 or may be erased from the disk 21 when it is moved to the disk 22.

It is to be noted that the content B which is a non-secure content cannot be moved (or copied) into the secure region 41-2 of the disk 22. Similarly, the content A which is a secure content cannot be moved (or copied) into the non-secure region 42-2 of the disk 22.

Further, the recording and reproduction apparatus 5-1 or 5-2 does not reproduce a non-secure content as a tune in order to protect the copyright. For example, since a content of tune data acquired by file exchange is not encrypted in accordance with the predetermined method, it is stored as a non-secure content, and the non-secure content is not reproduced as a tune at all although it is tune data. In particular, the recording and reproduction apparatus 5-1 or 5-2 does not recognize any data as a content of a tune other than data of a tune received from the EMD server 1 or read from a CD (Compact Disk) in accordance with a regular procedure. By the configuration, a content acquired illegally without depending upon the regular procedure has no value to the user of the recording and reproduction apparatus 5-1 or 5-2, and the protection of the copyright of contents can be consolidated.

Now, the disk 21 (or 22) loaded in the recording and reproduction apparatus 5-1 (5-2) is described.

The disk 21 is a magneto-optical disk and has physical attributes such as a form factor which are substantially same as those of a disk used in the MD (Mini Disc) system. As regards the format for recording and reproduction of the disk 21, three types are available including a disk used in an existing MD system, a disk of the next generation MD1 which uses a physical medium similar to that of the disk used in the existing MD system, and a disk of the next generation MD2 which has an outer profile same as the disk used in the existing MD system but has a raised recording density to further increase the recording capacity. The recording and reproduction apparatus 5-1 or 5-2 is configured so as to be compatible with (capable of recording or reproducing data on or from) any of the three types of disks.

Further, in order to record or reproduce content data such as tune data, the recording and reproduction apparatus 5-1 uses the FAT (File Allocation Table) system as a file management system. The disk of the next generation MD1 and the disk of the next generation MD2 are compatible with the FAT system, and therefore, the recording and reproduction apparatus 5-1 can assure the compatibility with an existing personal computer.

It is to be noted here that the term “FAT” or “FAT system” is used to generically call various PC-based file systems, but is not intended to indicate one of a particular FAT-based file system used in the DOS (Disk Operating System), the VFAT (Virtual FAT) used in the Windows (registered trademark) 95/98, the FAT32 used in the Windows (registered trademark) 98/ME/2000 and the NTFS (NT File System (also called New Technology File System).

In the existing MD system, a magneto-optical disk of a diameter of 64 mm accommodated in a cartridge is used as a recording medium. The disk has a thickness of 1.2 mm and has a center hole of a diameter of 11 mm perforated at the center thereof. The cartridge is shaped such that it has a length of 67 mm, a width of 72 mm and a thickness of 5 mm.

Also in both of the specifications of the next generation MD1 and the specifications of the next generation MD2, the shape of the disk and the shape of the cartridge are same.

Further, in a disk of the specification of the next generation MD2, a magnetic super-resolution technique or the like is used to enhance the recording capacity in the line density direction. The magnetic super-resolution technique makes use of the fact that, when a predetermined temperature is reached, a cut layer is placed into a magnetically neutral state, whereupon a magnetic wall transferred to a reproduction layer moves thereby to cause a small mark to look larger in a beam spot.

As regards the recording method, the groove recording method is adopted by both of the disk of the next generation MD1 and the next generation MD2. In other words, recording and reproduction wherein a groove (groove on a surface of a disk) is used as a track are used. As an error correction coding system, while a convolution code by the ACIRC (Advanced Cross Interleave Reed-Solomon Code) is used in the existing MD system, according to the specifications of the next generation MD1 and the next generation MD2, a block completed code which is a combination of the RS-LDC (Reed Solomon-Long Distance Code) and the BIS (Burst Indicator Subcode) is used. The adoption of the block completion type error correction code eliminates the necessity for a linking sector.

As regards the addressing method, the wobbled groove method is adopted wherein wobbles are formed as address information on the opposite sides of the groove formed as a single spiral groove. Such an addressing method as just described is called ADIP (Address in Pre-groove).

As regards the modulation method, while the existing MD system uses the EFM (8 to 14 Modulation), the next generation MD1 and the next generation MD2 adopt the RLL(1,7)PP (RLL: Run Length Limited, PP: Parity Preserve/Prohibit rmtr (repeated minimum transition runlength)) (hereinafter referred to as 1-7 pp modulation) Further, as the data detection method, the next generation MD1 uses the Viterbi decoding system in which the partial response PR(1,2,1)ML is used, and the next generation MD2 uses the Viterbi decoding system in which the partial response PR(1,−1)ML is used.

According to the specifications of the next generation MD1 wherein the disk used in the existing MD system is used as it is, the total data recording capacity per one disk is approximately 300 Mbytes (where an 80-minute disk is used). Since the modulation method is changed from the EFM to the 1-7 pp modulation, the window margin increases from 0.5 to 0.666, and in this regard, a higher recording density to 1.33 times can be implemented. Further, since the error correction method is changed from the ACIRC method to a combination of the BIS and the LDC, the data efficiency increases, and in this regard, a higher density to 1.48 times can be implemented. Totally, while a quite similar disk is used, increase of a data capacity to approximately twice can be implemented when compared with the existing MD system.

In the disk of the next generation MD2 which utilizes the magnetic super-resolution and so forth, further increase of the density in the linear density direction can be achieved, and the total data recording capacity becomes approximately 1 Gbyte.

FIG. 4 shows a configuration of the disk of the next generation MD1. The disk of the next generation MD1 uses the disk of the existing MD system as it is. In particular, the disk is formed by laminating a dielectric film, a magnetic film, another dielectric film and a reflection film on a transparent polycarbonate base plate. Further, a protective layer is laminated on the laminated films.

In the disk of the next generation MD1, a P-TOC (Pre-mastered TOC (Table Of Contents)) region is provided in a lead-in region on the innermost circumference (“innermost circumference” indicates a circumference on the most inner side in a radial direction from the center of the disk) in a recordable region of the disk among inner circumferences of the disk. The P-TOC region is a pre-mastered region as a physical structure. In other words, control information and so forth are recorded in the form of emboss pits, for example, as P-TOC information.

An outer circumference (circumference on the outer side in a radial direction from the center of the disk) of the lead-in region in which the P-TOC region is provided is formed as a recordable region (region which allows magneto-optical recording), that is, a recordable and reproducible region in which grooves are formed as guide grooves of recording tracks. A U-TOC (User TOC) is provided on the inner circumference of the recordable region.

The U-TOC has a configuration similar to that of the U-TOC used to record management information of a disk in the existing MD system. The U-TOC is management information which is re-written in accordance with a tune order, recording, erasure and so forth of tracks (audio tracks/data tracks) in the existing MD system and is used to manage the start position, end position and mode of each track (parts which form a track).

An alert track is provided on the outer circumference of the U-TOC. On the alert track, warning sound is recorded which is activated (outputted) by an MD player when the disk is loaded into an existing MD player. This warning sound represents that the disk is to be used in the next generation MD1 but cannot be reproduced by the existing system. The remaining portion of the recordable region extends in a radial direction to the lead-out region.

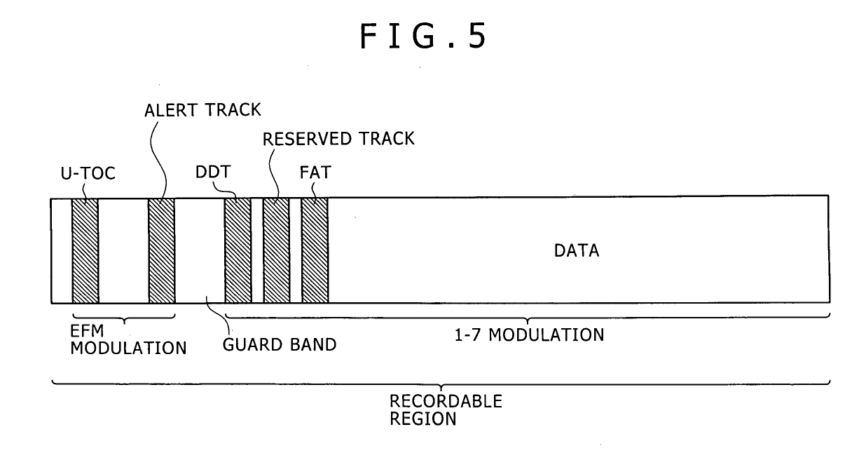

FIG. 5 illustrates a configuration of the recordable region of the disk according to the specifications of the next generation MD1 shown in FIG. 4. Referring to FIG. 5, the U-TOC and an alert track are provided at the top (inner circumference side) of the recordable region. In the region in which the U-TOC and the alert track are included, data are recorded in a form modulated by the EFM so that the data can be reproduced also by a player of the existing MD system. On the outer side of the region in which data are recorded in the EFM modulated form, a region is provided in which data are recorded in a form modulated by the 1-7 pp modulation of the next generation MD1. The region in which data are recorded in a form modulated by the EFM and the region in which data are recorded in a form modulated by the 1-7 pp modulation are spaced from each other by a predetermined distance, and a “guard band” is provided in the space. Since the guard band is provided, occurrence of some fault is prevented when a disk of the specifications of the next generation MD1 is loaded in an existing MD player.

At the top (inner circumference side) of the region in which data are recorded in a form modulated by the 1-7 pp modulation, a DDT (Disc Description Table) region and a reserved track are provided. The DDT region is provided in order to replace a region which has a physical defect. In the DDT region, an identification code unique to the disk is recorded. In the following description, an identification code unique to each disk is referred to as UID (Unique ID). In a disk of the next generation MD1, the UID is produced based on a random number generated in accordance with a predetermined process and is recorded, for example, upon initialization of the disk. Where the UID is used, each disk can be identified, and firm security management for recorded contents of each disk can be performed. The reserved track is used to store information for achieving protection of a content.

In the region in which data are recorded in a form modulated by the 1-7 pp modulation, a FAT (File Allocation Table) region is provided. The FAT region is provided to manage data in accordance with the FAT system. The FAT system manages data in conformity with the FAT system used in general purpose personal computers. The FAT system manages files through a FAT chain using a directory indicative of entry points of files and directories provided in the root and a FAT table in which connection information of FAT clusters is described.

In the disk of the specifications of the next generation MD1, information of the start position of the alert track and information of the start position of the region in which data are recorded in a form modulated by the 1-7 pp modulation are recorded in the U-TOC region. Further, decision information (for example, a character string such as “HIMD”) representing that the disk is of the next generation MD1 is recorded in the U-TOC region.

If a disk of the next generation MD1 is loaded into a player of the existing MD system, then the U-TOC region is read, and the position of the alert track is decided from the information of the U-TOC. Then, the alert track is accessed to start reproduction of the alert track. In the alert track, alarming sound representing that, for example, the disk is used in the next generation MD1 system and cannot be reproduced by a player of the existing MD system is recorded. From the alarming sound, the user is notified that the disk cannot be used in a player of the existing MD system.

If a disk of the next generation MD1 is loaded into a player ready for the next generation MD1 (for example, the recording and reproduction apparatus 5-1 or 5-2), then the U-TOC information is read, and the start position of the region in which data is recorded in a form modulated by the 1-7 pp modulation is decided from the U-TOC information. Then, the DDT, reserved track and FAT region are read. In the region of data of the 1-7 pp modulation, management of the data is performed by not using the U-TOC but using the FAT system.

FIG. 6 shows a configuration of the disk of the next generation MD2. The disk is formed by laminating a dielectric film, a magnetic film, another dielectric film and a reflection film on a transparent polycarbonate base plate. Further, a protective layer is laminated on the laminated films.

Referring to FIG. 6, in the disk of the next generation MD2, control information is recorded in the form of an ADIP signal in the lead-in region on the innermost circumference (circumference on the most inner side in a radial direction from the center of the disk) of the disk. The disk of the next generation MD2 does not have the P-TOC in the form of emboss bits provided in the lead-in region thereof, and instead, the control information in the form of an ADIP signal is used. A recordable region begins with an outer circumference of the lead-in region and forms a recordable and reproducible region in which grooves are formed as guide grooves of recording tracks. In the recordable region, data are recorded in a form modulated by the 1-7 pp modulation.

It is to be noted that, though not shown in FIG. 6, such a UID as described hereinabove is recorded in advance in a region for a consumer, which allows reproduction but does not allow recording, on the inner circumference side of the recordable region of a disk of the next generation MD2. In the case of the disk of the next generation MD2, the UID is recorded in advance upon manufacture of the disk using a technique similar to the BCA (Burst Cutting Area) technique used for the DVD (Digital Versatile Disc). Since the UID is produced upon manufacture of the disk, the UID can be managed, and the security can be enhanced when compared with an alternative case wherein the UID is produced based on a random number upon initialization of the disk according to the next generation MD1 described hereinabove.

It is to be noted that the region of a disk of the next generation MD2 in which the UID is recorded is hereinafter referred to as BCA.

Whether the disk is of the next generation MD1 or of the next generation MD2 can be decided, for example, from information in the lead-in region. In particular, if a P-TOC in the form of emboss pits is detected in the lead-in region, then it can be decided that the disk is an existing MD or a disk of the next generation MD1. If control information in the form of an ADIP signal is detected but a P-TOC in the form of emboss pits is not detected in the lead-in region, then it can be decided that the disk is of the next generation MD2. Such decision can be made also depending upon whether or not a UID is recorded in the BCA described hereinabove. It is to be noted that the decision between the disk of the next generation MD1 and the disk of the next generation MD2 is not limited to the methods just described. For example, it is possible to make the decision from the phases of a tracking error signal in an on-track state and an off-track state. Naturally, a detection hole for disk identification may be provided alternatively.

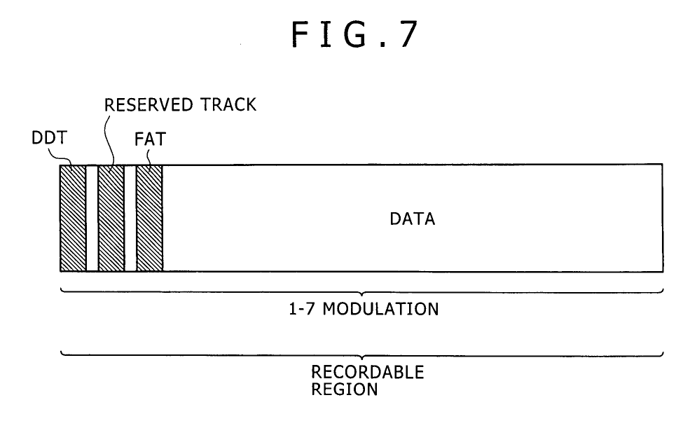

FIG. 7 shows a configuration of the recordable region of the disk of the next generation MD2. Referring to FIG. 7, in the recordable region, all data are recorded in a form modulated by the 1-7 pp modulation, and a DDT region and a reserved track are provided at the top (inner circumference side) in the region in which data are recorded in a form modulated by the 1-7 pp modulation. The DDT region is provided to record alternative region management data for managing an alternative region for a region which has a physical defect.

More particularly, in the DDT region, a management table is recorded which manages a replacement region including the recordable region which replaces such a region which has a physical defect as described above. The management table records a logical cluster decided to be defective and also a logical cluster (one or a plurality of logical clusters) within the replacement region allocated as a cluster to replace the defective logical cluster. Further, the UID described hereinabove is recorded in the DDT region. The reserved track has information for the protection of a content accommodated therein.

Furthermore, in the region in which data are recorded in a form modulated by the 1-7 pp modulation, a FAT region is provided. The FAT region is used to manage data in accordance with the FAT system. The FAT system manages data in conformity with the FAT system used in general purpose personal computers.

The disk of the next generation MD2 has no U-TOC region provided thereon. If a disk of the next generation MD2 is loaded into a player complying with the disk of the next generation MD2, then the DDT, reserved track and FAT region at predetermined positions are read, and management of data is performed using the FAT system.

In the disk of the next generation MD1 and the disk of the next generation MD2, initialization operation which requires much time is not required. In particular, in the disk of the next generation MD1 and the disk of the next generation MD2, initialization operation is not required except for production of minimum necessary tables such as the DDT, reserved tracks and FAT table. Thus, recording and reproduction of the recordable region can be performed directly for a disk which has not been used as yet.

It is to be noted that, while the disk of the next generation MD2 allows firmer security management because the UID is produced and recorded upon manufacture of the disk as described above, it has a greater number of laminated layers of films than a disk used in the existing MD system and consequently is more expensive. Therefore, also a disk system (hereinafter referred to as next generation MD1.5) has been proposed wherein the recordable region and the lead-in and lead-out regions of the disk are common to those of the disk of the next generation MD1 while only the UID is recorded upon manufacture of the disk similarly as in the disk of the next generation MD2 using the BCA similar to that of the DVD. In the present specification, description of the next generation MD1.5 is omitted except where this is required specifically. In other words, the next generation MD1.5 conforms to the next generation MD1 in regard to the UID but conforms to the disk of the next generation MD2 in regard to recording, reproduction and so forth of audio data.

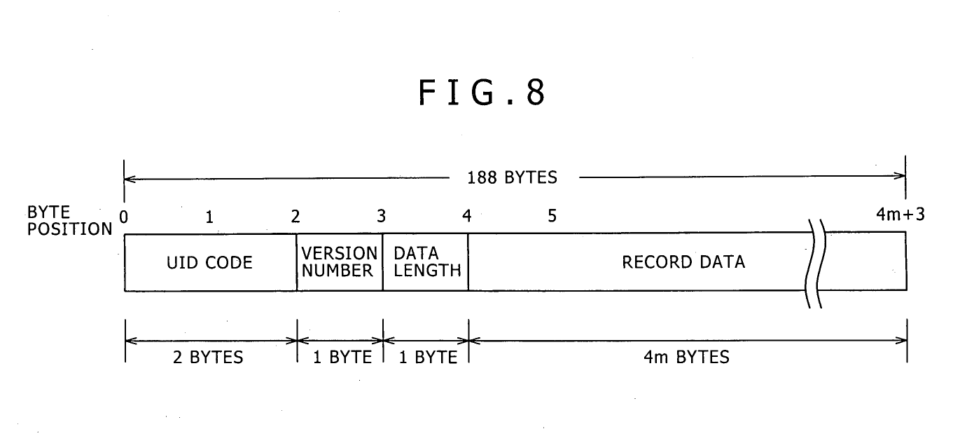

The UID described above is described more particularly. As described hereinabove, the UID in the disk of the next generation MD2 is recorded in advance upon manufacture of the disk using a technique similar to the technique called BCA which is used for the DVD. FIG. 8 schematically shows an example of a format of the UID. The entire UID is referred to as UID record block.

In the UID block, a portion of 2 bytes from the top is used as a field for a UID code. In the UID code, top four bits from among 2 bytes, that is, 16 bits, are used for disk identification. For example, if the 4 bits are “0000”, then they indicate that the disk is of the next generation MD2, and if the 4 bits are “0001”, then they indicate that the disk is of the next generation MD1.5. The other values of the top 4 bits of the UID code are reserved, for example, for future expansion. The lower 12 bits of the UID code are used for an application ID and is ready, for example, for 4,096 different application services.

The UID code is followed by a field of 1 byte for a version number and further by a field of 1 byte for a data length. This data length indicates the data length of a field for UID record data disposed next to the data length. The field for UID record data is disposed by 4m (m=0, 1, 2, . . . ) bytes within a range which the data length of the entire UID does not exceed 188 bytes. A unique ID produced by a predetermined method can be placed into the field for UID record data, and the individual disk can be identified based on the ID.

It is to be noted that, in the disk of the next generation MD1, an ID produced based on a random number is recorded in the field for UID record data.

A plurality of such UID record blocks can be formed with the data length of up to 188 bytes.

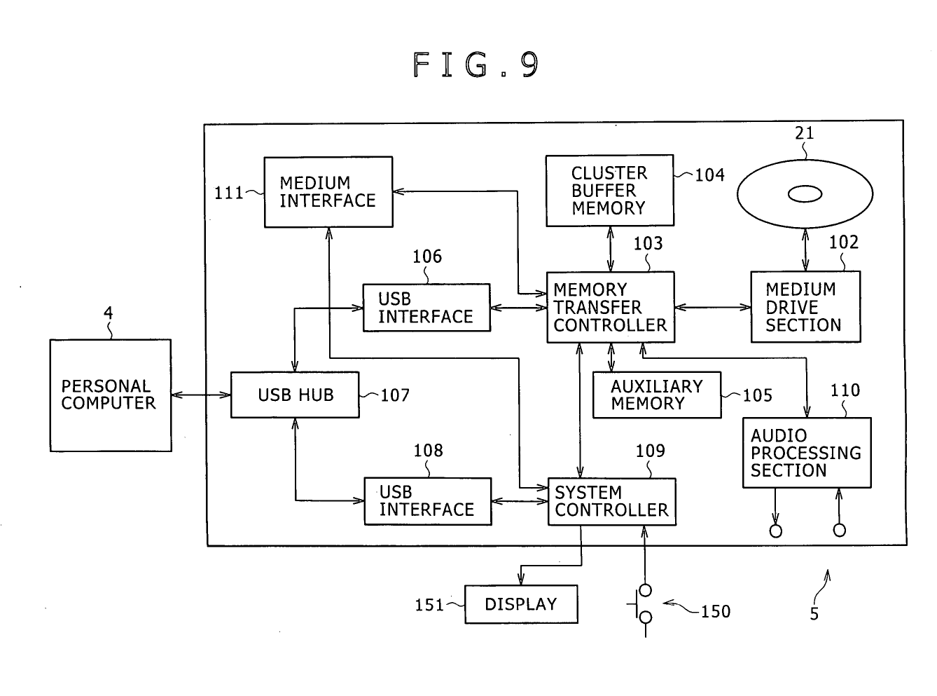

Now, a configuration of the recording and reproduction apparatus 5-1 or 5-2 is described. It is to be noted that, where there is no necessity to distinguish the recording and reproduction apparatus 5-1 and 5-2, any of them is referred to merely as recording and reproduction apparatus 5. FIG. 9 shows an example of a configuration of the recording and reproduction apparatus 5.

Referring to FIG. 9, the recording and reproduction apparatus 5 includes a medium drive section 102, a memory transfer controller 103, a cluster buffer memory 104 and an auxiliary memory 105. The recording and reproduction apparatus 5 further includes a pair of USB (Universal Serial Bus) interfaces 106 and 108, a USB hub 107, a system controller 109, and an audio processing section 110.

The medium drive section 102 performs recording/reproduction on/from a disk 21 loaded therein. The disk 21 is a disk of the next generation MD1, a disk of the next generation MD2 or a disk of the existing MD system as described hereinabove.

The memory transfer controller 103 performs transfer of reproduction data from the medium drive section 102 or recording data to be supplied to the medium drive section 102.

The cluster buffer memory 104 buffers data read out in a unit of a recording block from a data track of the disk 21 by the medium drive section 102 under the control of the memory transfer controller 103.

The auxiliary memory 105 stores data, various kinds of management information, special information and so forth read out from the disk 21 by the medium drive section 102 under the control of the memory transfer controller 103.

The system controller 109 controls the components of the recording and reproduction apparatus 5 and performs communication control with the personal computer 4 connected to the recording and reproduction apparatus 5.

In particular, the system controller 109 can communicate with the personal computer 4 connected thereto through the USB interface 108 and the USB hub 107 and performs reception of a command such as a write request or a readout request, transmission of status information and other necessary information, and so forth.

The system controller 109 issues an instruction to the medium drive section 102 to read out management information and so forth from the disk 21, for example, in response to loading of the disk 21 into the medium drive section 102 and controls the auxiliary memory 105 to store the management information and so forth read out by the memory transfer controller 103.

If a readout request of a certain FAT sector is received from the personal computer 4, then the system controller 109 controls the medium drive section 102 to read out a block including the FAT sector. Read out data of the data block are written into the cluster buffer memory 104 by the memory transfer controller 103.

The system controller 109 controls the memory transfer controller 103 to cause the cluster buffer memory 104 to read out the requested data of the FAT sector from among data of the data block written in the cluster buffer memory 104 and transmit the read out data to the personal computer 4 through the USB interface 106 and the USB hub 107.

For example, if a write request of a certain FAT sector is received from the personal computer 4, then the system controller 109 controls the memory transfer controller 103 to cause the medium drive section 102 to first read out a data block including the FAT sector. The read out data block is written into the cluster buffer memory 104 by the memory transfer controller 103.

The system controller 109 controls the memory transfer controller 103 to cause the USB interface 106 to supply the data of the FAT sector from the personal computer 4 to the memory transfer controller 103 so that the re-writing of the data of the pertaining FAT sector is executed on the cluster buffer memory 104.

The system controller 109 issues an instruction to the memory transfer controller 103 to transfer the data of the data block stored in the cluster buffer memory 104 in a state wherein the necessary FAT sector is re-written as recording data to the medium drive section 102. The medium drive section 102 modulates the recording data of the data block and writes the modulated recording data on the disk 21.

A switch 150 is connected to the system controller 109. The switch 150 sets the operation mode of the recording and reproduction apparatus 5 to one of the next generation MD1 system and the existing MD system. In other words, the recording and reproduction apparatus 5 can perform recording of audio data in both of the format of the existing MD system and the format of the next generation MD1 system on the disk 21 of the existing MD system. The operation mode of the recording and reproduction apparatus 5 can be indicated explicitly to the user by means of the switch 150. Although a switch of a mechanical structure is shown as the switch 150 in FIG. 9, another switch which makes use of the electricity or the magnetism or a hybrid type switch can be used instead.

A display unit 151 is formed from, for example, a liquid crystal display (LCD) panel and displays text data, simple icons and so forth to present information regarding a state of the recording and reproduction apparatus 5, a message and so forth to the user in accordance with a display control signal supplied thereto from the system controller 109.

The audio processing section 110 includes, as input systems thereof, an analog audio signal inputting section such as, for example, a line inputting circuit/microphone inputting circuit, an A/D converter, and a digital audio data inputting section, and controls inputting/outputting of audio data. Further, the audio processing section 110 includes an ATRAC compression encoder/decoder and a buffer memory for compressed data and controls encoding and decoding processes of audio data. Furthermore, the audio processing section 110 includes, as output systems thereof, a digital audio data outputting section, a D/A converter and an analog audio signal outputting section such as a line outputting circuit/headphone outputting circuit.

A medium interface 111 controls transmission/reception of data to and from a medium other than the disk 21. For example, the medium interface 111 may allow connection thereof to a disk 22 (recording and reproduction apparatus 5-2) or to another medium drive for driving a medium such as a memory card or an optical disk.

It is to be noted that the connection to the personal computer 4 is not limited to the USB, but some other external interface such as the IEEE (Institute of Electrical and Electronics Engineers) 1394 or a radio connection may be used instead.

Now, a data management method by the recording and reproduction apparatus 5 is described. The recording and reproduction apparatus 5 can make use of a disk of the next generation MD1 or of the next generation MD2 to record a secure content.

As described hereinabove, in the systems of the next generation MD1 and the next generation MD2, data are managed by the FAT system. Further, a secure content (for example, audio data) to be recorded is compressed by a desired compression method and encrypted for the protection of the right of the author. The compression method for audio data may be, for example, ATRAC3, ATRAC5 or the like. Naturally, any other compression method such as MP3 (MPEG Audio Layer-3) or AAC (MPEG2 Advanced Audio Coding) may be used.

Further, as the secure content, not only audio data but also still picture data or moving picture data may be handled. Naturally, since the FAT system is used, it is possible to record and reproduce also general purpose data such as text data. Furthermore, also it is possible to encode a command which can be read and executed by a computer on a disk, and the next generation MD1 or the next generation MD2 may include an executable file.

A management method when audio data are recorded and reproduced as a secure content on and from such disks of the next generation MD1 and the next generation MD2 as described above is described.

In the next generation MD1 system and the next generation MD2 system, since music data of a high sound quality for a long period of time can be reproduced, also the number of tunes managed on one disk is very great. Further, since the FAT system is used for the management, the affinity with a computer is achieved. Consequently, while there is a merit that enhancement of the convenience to the user can be achieved, there is the possibility that music data may be copied illegally and the protection of the owner of the copyright may not be secured. Therefore, a secure content is recorded in an encrypted form as described hereinabove. Here, a management method for audio data as a secure content is described in connection with two examples.

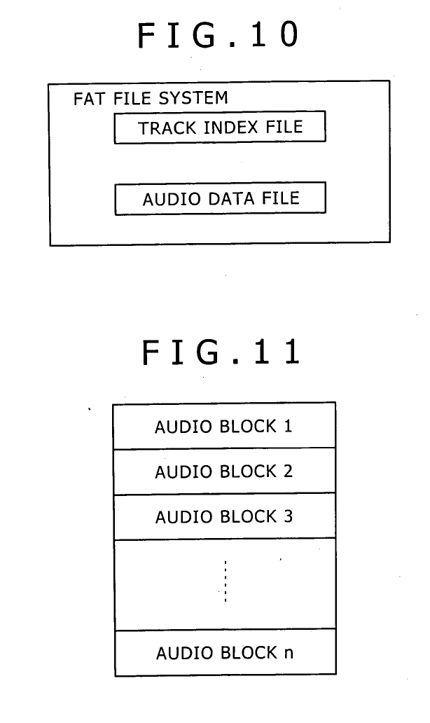

FIG. 10 illustrates a first management method for audio data. Referring to FIG. 10, according to the first management method, a track index file and an audio data file are produced on a disk. The track index file and the audio data file are managed by the FAT system.

The audio data file includes a plurality of music data stored as a single file as seen in FIG. 11. Where the audio file is viewed from the FAT system, it looks like a huge file. The audio data file is divided into parts in the inside thereof, and the audio data are handled as a set of parts.

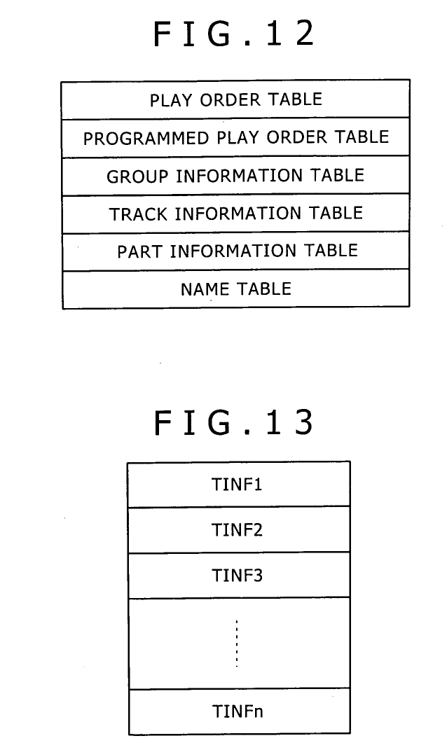

The track index file is a file which describes various kinds of information for managing the music data stored in the audio data file. The track index file includes, for example, as seen in FIG. 12, a play order table, a programmed play order table, a group information table, a track information table, a part information table, and a name table.

The play order table indicates a reproduction order defined in default. The play order table stores, as seen in FIG. 13, information TINF1, TINF2, . . . indicative of link destinations to track descriptors (hereinafter described) of the track information table regarding individual track numbers (tune numbers). The track numbers are consecutive numbers beginning with, for example, “1”.

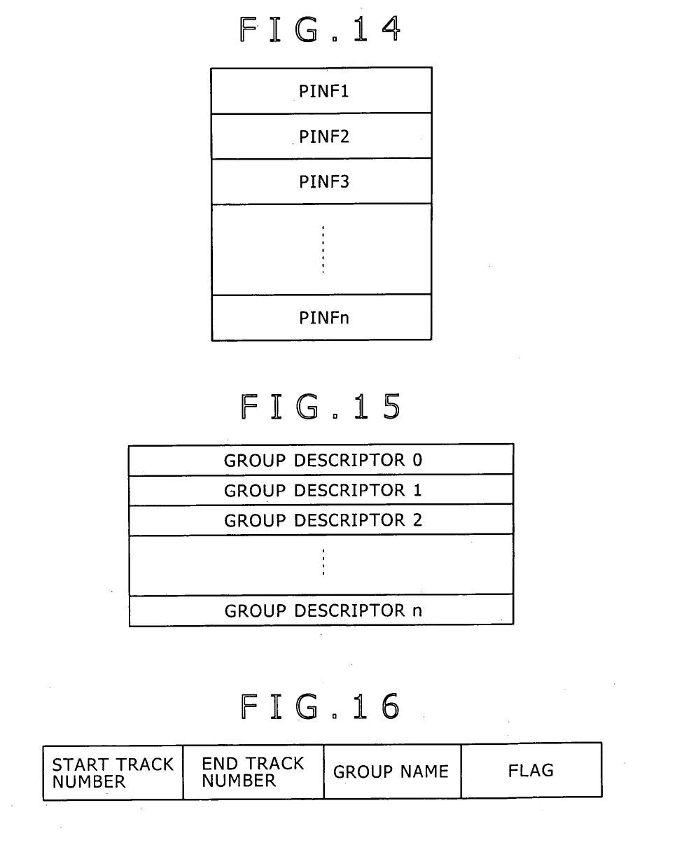

The programmed play order table stores a reproduction order defined by each user. The programmed play order table describes track information PINF1, PINF2, of link destinations to track descriptors regarding the individual track numbers as seen in FIG. 14.

The group information table describes information regarding groups. Here, a group is a set of more than one track having consecutive track numbers or a set of more than one track having consecutive programmed track numbers. The group information table is described in group descriptors of the individual groups as seen in FIG. 15. Further, each group descriptor describes a track number at which the group begins, a number of an end track, a group name and a flag.

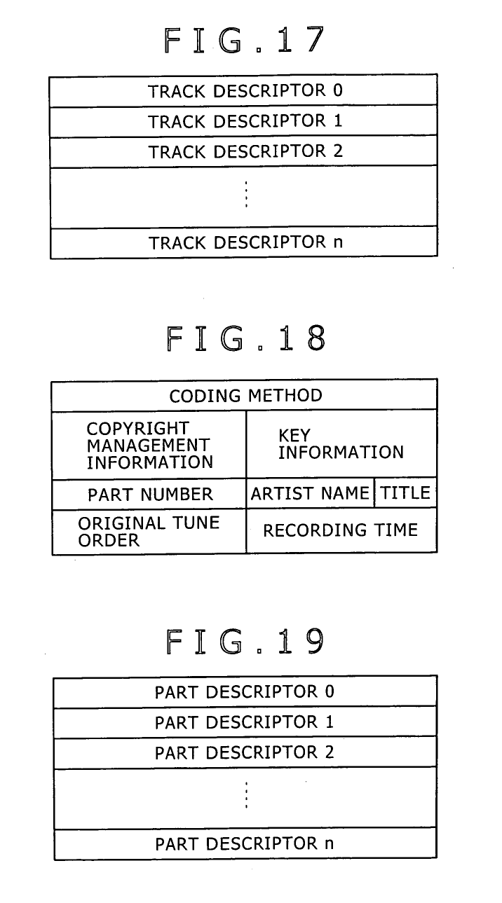

The track information table describes information regarding the individual tunes. The track information table includes track descriptors of the individual tracks (individual tunes) as seen in FIG. 17. Each track descriptor describes, as seen in FIG. 18, a coding system, copyright management information, decryption key information of the content, pointer information to the part number which makes an entry at which the tune starts, an artist name, a title name, original tune order information and recording time information. The artist name and the title name may not each describe the name itself but describe pointer information to the name table.

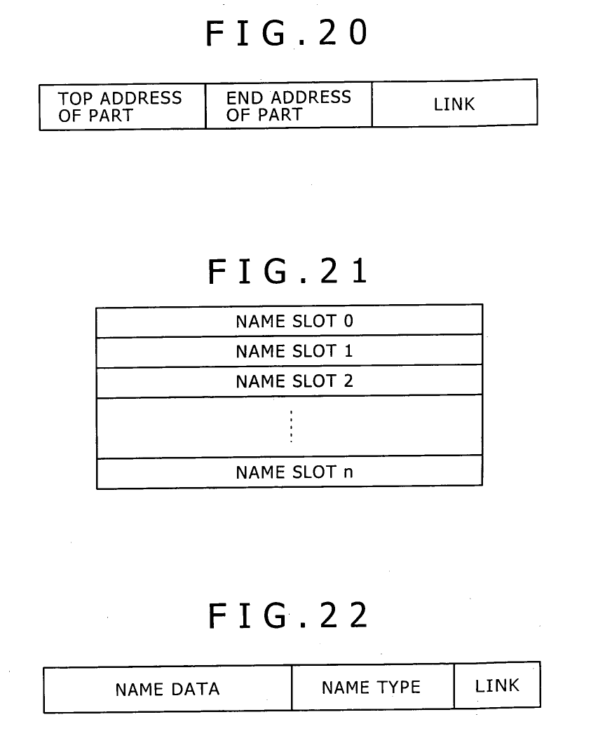

The part information table describes a pointer for accessing an actual position of a tune from a part number. The part information table includes part descriptors for individual parts as seen in FIG. 19. A part is a portion which is an entire one track (tune) or is one of divisions when one track is divided. FIG. 20 illustrates an example of a configuration of a part descriptor in the part information table. Referring to FIG. 20, the part descriptor describes the top address of the part on the audio data file, the end address of the part, and a link destination to a succeeding part.

The name table represents characters of the entity of a name. As seen from FIG. 21, the name table includes a plurality of name slots. Each name slot is linked to and called from a pointer indicating a name. The pointer for calling a name may be an artist name or a title name of the track information table and a group name of the group information table or the like. Further, each name slot can be called from a plurality of calling sources. Each name slot includes, as seen in FIG. 22, name data of character information, a name type which is an attribute of the character information, and a link destination. Where the name is so long that it cannot be accommodated in one name slot, it can be described divisionally in a plurality of name slots. Further, where a name cannot be accommodated in one slot, a link destination to a name slot in which the succeeding name is described is described in the name slot.

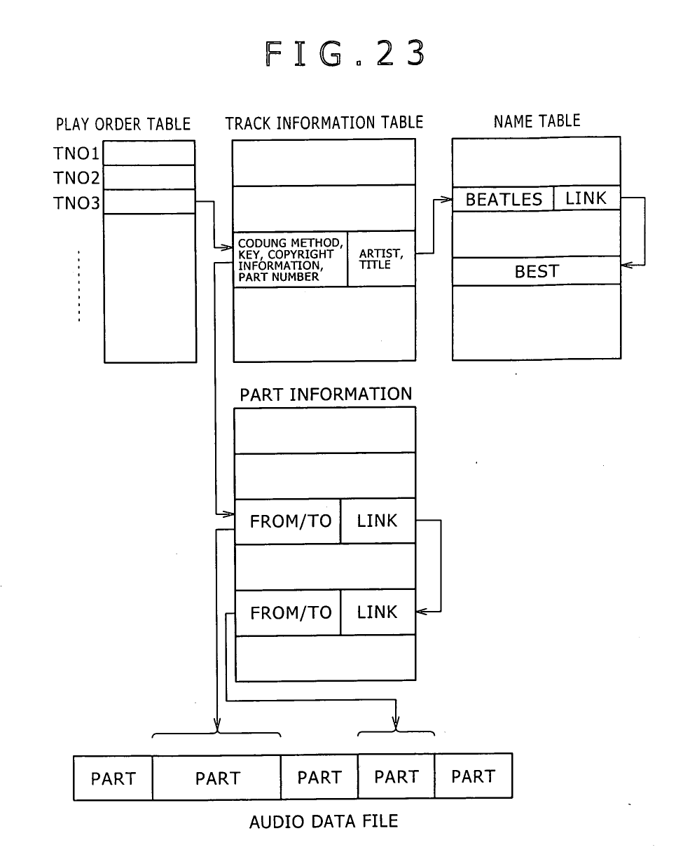

In the first management method of audio data, if a track number to be reproduced is designated by the play order table (FIG. 13) as seen in FIG. 23, then the track descriptor (FIG. 17) of the link destination of the track information table is read out. Then, from the track descriptor, a coding system, copyright management information, decryption key information of the content, pointer information to a part number at which the tune starts, pointers to the artist name and the title name, original tune order information, recording time information and so forth are read out.

From the information of the part number read out from the track information table, the part information table (FIG. 19) is linked, and from the part information table, an audio data file at the position of the part corresponding to the starting position of the track (tune) is accessed. After the data of the part at the position designated by the part information table of the audio data file is accessed, reproduction of the audio data is started from the position. At this time, decoding is performed in accordance with the coding system read out from the track descriptor of the track information table. If the audio data are in an encrypted state, then key information read out from the track descriptor is used.

If a part following the part exists, then the link destination of the part is described in the part descriptor, and part descriptors are successively read out in accordance with the link destination. The link destinations of the part descriptors are traced to reproduce the audio data of the parts at the positions designated by the individual part descriptors on the audio data file. The audio data of the desired track (tune) can be reproduced thereby.

Further, the name slot (FIG. 21) of the name table at a position (name pointer information) indicated by the pointer of an artist name or a title name read out from the track information table is called, and name data are read out from the name slot at the position.

In this manner, when audio data are to be reproduced, the positions of parts which form the audio data are specified based on the track information table, and decoding is performed based on a coding system read out from the track descriptor of the track information table. Further, encrypted audio data are decrypted based on key information read out from the track descriptor. Accordingly, data which do not comply with the present management method (in the present case, data whose predetermined information is not described in the track information table) cannot be reproduced by the recording and reproduction apparatus 5 even if the data are audio data. In this manner, copyright protection of a secure content can be secured further firmly.

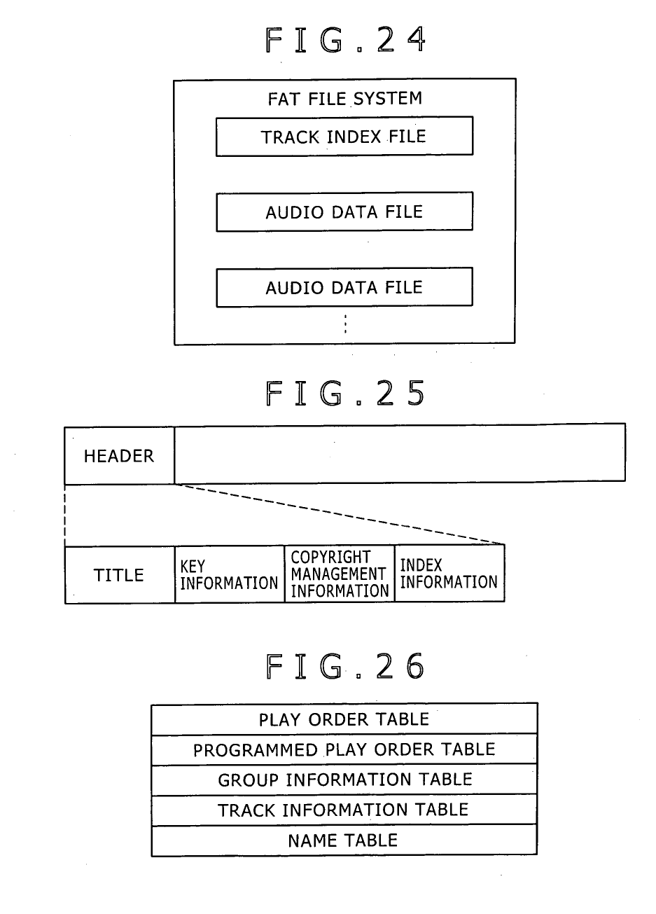

Now, an example of the second management method for audio data is described. Referring to FIG. 24, according to the second management method, a track index file and a plurality of audio data files are produced on a disk. The track index file and a plurality of the audio data files are managed by the FAT system.

An audio data file accommodates music data of one tune in principle as seen in FIG. 25. The audio data file includes a header. The header has a title, decryption key information and copyright management information recorded therein and includes index information. The index divides a tune of one track into a plurality of portions. In the header, the position of each track divided by the index is recorded corresponding to an index number. For example, 255 indices can be set.

The track index file describes various kinds of information for managing music data accommodated in the audio data file. As seen in FIG. 26, the track index file includes a play order table, a programmed play order table, a group information table, a track information table, and a name table.

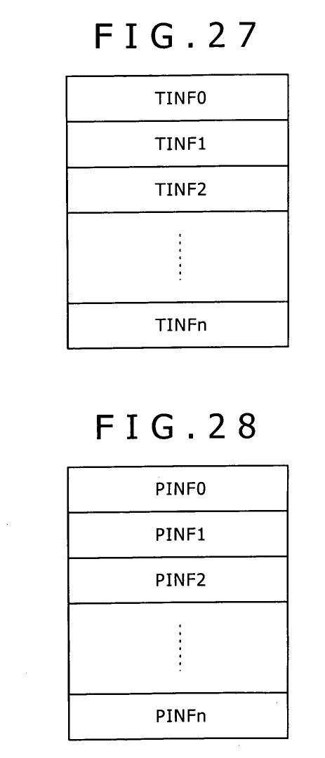

The play order table indicates a reproduction order defined in default. The play order table stores, as seen in FIG. 27, information TINF1, TINF2, . . . indicative of link destinations to track descriptors (FIG. 31) of the track information table regarding individual track numbers (tune numbers). The track numbers are consecutive numbers beginning with, for example, “1”.

The programmed play order table stores a reproduction order defined by each user. The programmed play order table describes information track information PINF1, PINF2, . . . of link destinations to track descriptors regarding the individual track numbers as seen in FIG. 28.

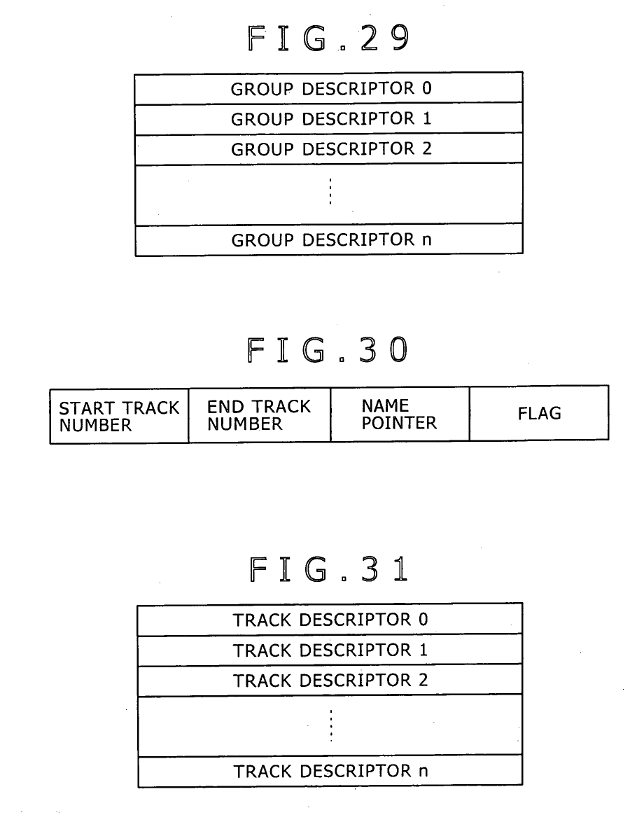

The group information table describes information regarding groups as seen in FIG. 29. Here, a group is a set of more than one track having consecutive track numbers or a set of more than one track having consecutive programmed track numbers. The group information table is described in group descriptors of the individual groups as seen in FIG. 30. Each group descriptor describes the track number at which the group begins, the number of an end track, a group name and a flag.

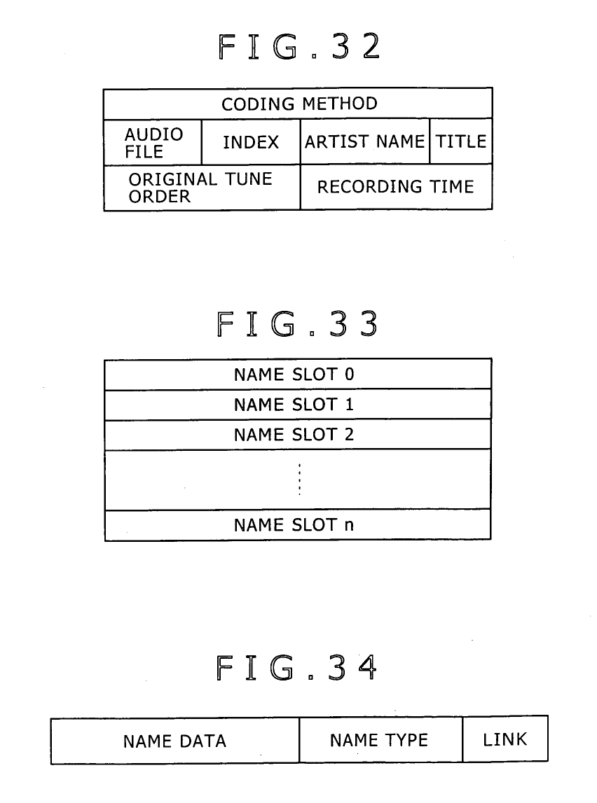

The track information table describes information regarding the individual tunes. The track information table includes track descriptors of the individual tracks (individual tunes) as seen in FIG. 31. Each track descriptor describes, as seen in FIG. 32, a pointer of a file of an audio data file in which the tune is accommodated, an index number, an artist name, a title name, original tune order information and recording time information. The artist name and the title name may not each describe the name itself but describe a pointer to the name table.

The name table represents characters of the entity of a name. As seen from FIG. 33, the name table includes a plurality of name slots. Each name slot is linked to and called from a pointer indicating a name. The pointer for calling a name may be an artist name or a title name of the track information table, a group name of the group information table or the like. Further, each name slot can be called from a plurality of calling sources. Each name slot includes, as seen in FIG. 34, name data, a name type, and a link destination. Where the name is so long that it cannot be accommodated in one name slot, it can be described divisionally in a plurality of name slots. Further, where a name cannot be accommodated in one slot, a link destination to a name slot in which the succeeding name is described is described in the name slot.

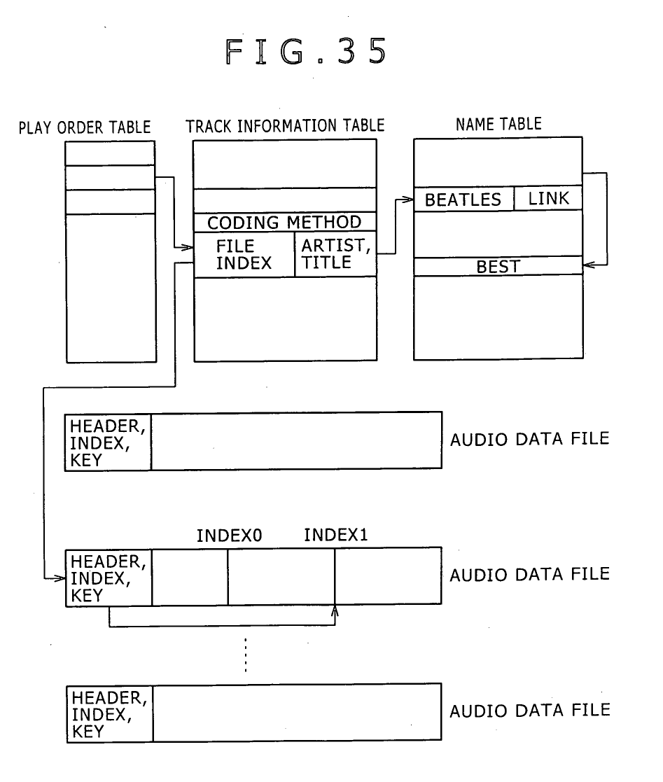

In the second management method of audio data, if a track number to be reproduced is designated by the play order table (FIG. 27) as seen in FIG. 35, then the track descriptor (FIG. 31) of the link destination of the track information table is read out. Then, from the track descriptor, a file pointer and an index number of the tune, pointers to the artist name and the title name, original tune order information, recording time information and so forth are read out.

From the pointer of the file of the tune, the audio data file is accessed, and information of the header of the audio data file is read. Where the audio data are in an encrypted form, key information read out from the header is used. Then, the audio data file is reproduced. At this time, if an index number is designated, then the position of the designated index number is detected from the information of the header, and reproduction is started from the position of the index number.

Then, the name slot of the name table which is positioned at a position indicated by the pointer of the artist name or the title name read out from the track information table is read out. Then, name data are read out from the name slot at the position.

In this manner, when audio data are to be reproduced, the file pointer of the tune is specified from the track descriptor of the track information table, and the audio file of the tune is specified based on the file pointer. Further, encrypted audio data are decrypted based on key information included in the header of the audio file. Accordingly, data which do not comply with the present management method cannot be reproduced by the recording and reproduction apparatus 5 even if the data are audio data. In this manner, copyright protection of a secure content can be secured further firmly.

A secure content recorded and reproduced by such a management system as described above is moved from the disk 21 to the disk 22 as described hereinabove with reference to FIG. 3.

FIG. 36 shows an example of a functional configuration of software executed by the system controller 109 shown in FIG. 9.

Referring to FIG. 36, an operation input acceptance section 201 accepts an input of an operation by a user and outputs a command or the like corresponding to the substance of the operation to a disk type decision section 202, a content movement control section 203 and a data copying control section 204.

The disk type decision section 202 decides whether the type of the disk loaded in the recording and reproduction apparatus 5 is a disk of the existing MD system, a disk of the next generation MD1 or a disk of the next generation MD2. The disk type decision section 202 outputs a result of the decision to the content movement control section 203 or the data copying control section 204.

The content movement control section 203 controls the movement of the content from a disk to another disk based on the result of the decision of the disk type decision section 202.

The data copying control section 204 controls copying of the data (content) from the disk to the auxiliary memory 105 or from the auxiliary memory 105 to the disk based on the result of the decision of the disk type decision section 202.

A disk recording execution section 205 controls the medium drive section 102 in accordance with an instruction from the content movement control section 203 or the data copying control section 204 to perform writing of the data on the disk.

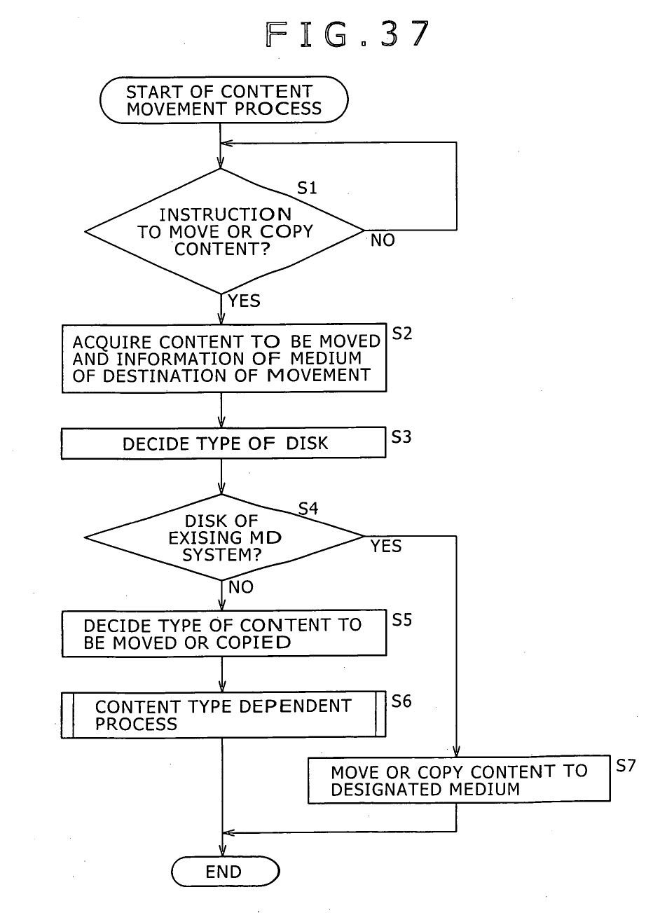

Now, a content movement process by the recording and reproduction apparatus 5 for moving (or copying) a content between media is described with reference to a flow chart of FIG. 37. The content movement process is executed, for example, when the user operates the inputting section not shown based on the displayed substance of the display unit 151 to issue an instruction to move a content between different media. Here, description is given of an example wherein a content recorded on the disk 21 is moved from the recording and reproduction apparatus 5-1 to the disk 22 of the recording and reproduction apparatus 5-2.

At step S1, the operation input acceptance section 201 decides whether or not an instruction to move or copy a content is issued by an operation of the user, and waits until it decides that an instruction to move or copy a content is issued.

At step S2, the operation input acceptance section 201 acquires information of the content to be moved and a medium of the destination of the movement based on the substance of the instruction decided at step S1. In the present case, as the content to be moved, the name of a content (for example, content A, content B or the like) recorded on the disk 21 is acquired, and as information of the medium of the destination of the movement, information specifying the disk 22 is acquired.

At step S3, the disk type decision section 202 decides the type of the disk of the source of the movement. In the present case, it is decided whether the type of the disk 21 is a disk of the current MD system, a disk of the next generation MD1 or a disk of the next generation MD2.

The decision of the type of the disk is performed, for example, in the following manner. In particular, if a P-TOC in the form of emboss pits is detected in the lead-in region, then it can be decided that the disk is a disk of the existing MD system or of the next generation MD1. Then, if predetermined information such as warning sound is not recorded in the alert track on the outer circumference of the U-TOC, it can be determined that the disk is of the existing MD system. On the other hand, if control information in the form of an ADIP signal is detected in the lead-in region and a P-TOC in the form of emboss pits is not detected, then it can be decided that the disk is of the next generation MD2.

Alternatively, a rising edge, a falling edge or the like of a servo signal may be discriminated so that only a disk of the next generation MD2 is selectively decided, whereafter a disk of the next generation MD1 is selectively decided based on decision information (for example, a character string of “HIMD” or the like) of a predetermined recording position in the U-TOC.

It is to be noted that the decision method of the type of a disk is not limited to those described above, but it is possible to make the decision of the type of a disk from the phases of a tracking error signal in an on-track state and an off-track state. Naturally, a detection hole for disk identification may be provided alternatively.

At step S4, the disk type decision section 202 decides whether or not the result of the decision by the process at step S3 indicates a disk of the existing MD system. If it is decided that the disk is not of the existing MD system, that is, if it is decided that the disk is either a disk of the next generation MD1 or a disk of the next generation MD2, then the processing advances to step S5.

At step S5, the content movement control section 203 decides the type of the content to be moved (or copied). Here, it is decided, as the type of the content, whether the content is a secure content or a non-secure content.

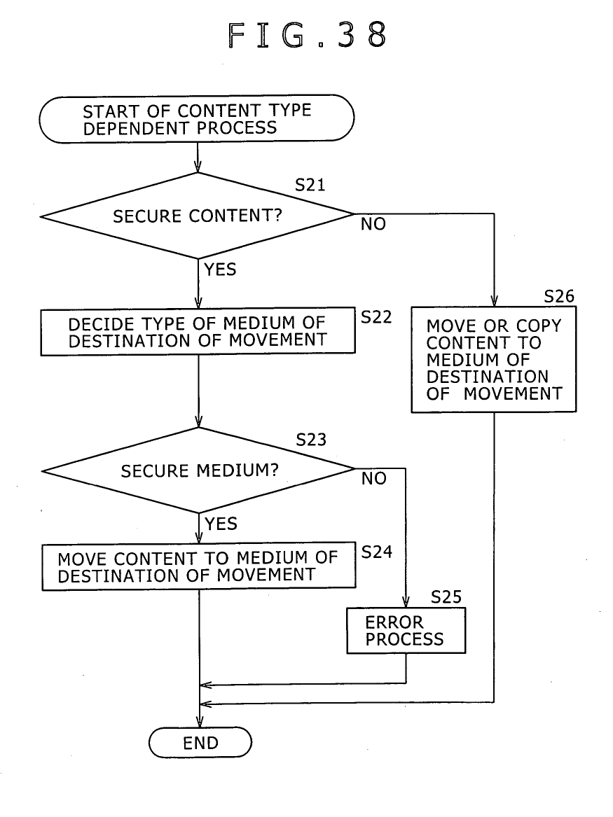

At step S6, the content movement control section 203 executes a content type dependent process hereinafter described with reference to FIG. 38. Consequently, movement or copying of the content is performed depending upon whether the content is a secure content or a non-secure content.

If it is decided at step S4 that the disk of the source of movement is of the existing MD system, then the processing advances to step S8. At step S8, the disk recording execution section 205 accesses the recording and reproduction apparatus 5-2 through the medium interface 111 to move the content to the disk 22 which is a medium of the destination of the movement. In other words, since a secure content cannot be recorded on a disk of the existing MD system, movement or copying of a non-secure content is performed.

Now, details of the content type decision process at step S6 of FIG. 37 is described with reference to FIG. 38.

At step S21, the content movement control section 203 decides whether or not the result of the decision at step S5 indicates that the content to be moved or copied is a secure content. If it is decided that the content is a secure content, then the processing advances to step S22.

At step S22, the content movement control section 203 decides the type of the medium of the destination of the movement. At this time, information regarding the type of the disk 22 is acquired from the recording and reproduction apparatus 5-2 through the medium interface 111. In this instance, the recording and reproduction apparatus 5-2 decides the type of the disk 22 in a similar manner as in the process at step S3 and transmits a result of the decision through the medium interface 111.

At step S23, the content movement control section 203 decides whether or not the type of the medium decided by the process at step S22 is a secure medium. Here, the secure medium signifies a medium compatible with the secure content management method described hereinabove with reference to FIGS. 10 to 35, and a disk of the next generation MD1 or a disk of the next generation MD2 is decided as a secure disk.

If it is decided at step S23 that the type of the medium of the destination of the movement is a secure medium, then the processing advances to step S24. At step S24, the content movement control section 203 controls the disk recording execution section 205 to access the recording and reproduction apparatus 5-2 through the medium interface 111 to move the content to the disk 22 which is a medium of the destination of the movement. Consequently, the content A which is a secure content is moved to the disk 22 as described hereinabove with reference to FIG. 3. It is to be noted that copying of a secure content is not permitted but only movement is permitted as described hereinabove with reference to FIG. 3.

On the other hand, if it is decided at step S23 that the type of the medium of the destination of the movement is not a secure medium, then the processing advances to step S25, at which the content movement control section 203 performs an error process. In particular, since a secure content cannot be moved to a medium which is not a secure medium, such movement is determined to be a processing error. At this time, for example, a message representing that the content cannot be moved because the medium of the destination of the movement is not a secure medium is displayed on the display unit 151 so that the user may be notified of this.

On the other hand, if it is decided at step S21 that the content to be moved or copied is not a secure content (or in other words, is a non-secure content), then the processing advances to step S26. At step S26, the content movement control section 203 controls the disk recording execution section 205 to access the recording and reproduction apparatus 5-2 through the medium interface 111 to move the content to the disk 22 which is a medium of the destination of the movement. Consequently, the content B which is a non-secure content is moved to the disk 22 as described hereinabove with reference to FIG. 3.

Movement (or copying) of a content between different media is performed in such a manner as described above. Since it is decided whether a content to be moved or copied is a secure content or a non-secure content and it is decided, if the content is a secure content, whether or not the medium of the destination of the movement is a secure medium to perform movement of the content, the copyright of the content can be protected further firmly and appropriately.

It is to be noted that, while, in the example described above, a content is moved from the disk 21 of the recording and reproduction apparatus 5-1 to the disk 22 of the recording and reproduction apparatus 5-2, for example, a new medium drive section may be connected through the medium interface 111 such that the disk 22 is loaded into the medium drive section. In other words, the recording and reproduction apparatus 5-1 may include two medium drive sections such that the disk 21 and the disk 22 are loaded into the recording and reproduction apparatus 5-1. Also in this instance, a content movement process can be performed in such a manner as described hereinabove with reference to FIGS. 37 and 38.

Further, while, in the example described above, a content is moved from a disk to another disk, a content may be moved otherwise, for example, from a disk to such a medium as a memory card. In this instance, it is decided at step S22 of FIG. 38 whether or not the medium of the destination of the movement is a medium which can manage a secure content such as, for example, a magic gate memory stick interface (MGMS) (trademark), a memory stick pro (MSpro) (trademark).

Or else, another portable device which is formed, for example, from a portable telephone set and can manage a secure content is connected through the medium interface 111 such that a content is moved from the disk 21 to a recording section built in the portable device.

Incidentally, while the recording and reproduction apparatus 5 described above performs principally recording/reproduction of audio data, the application of the recording and reproduction apparatus 5 is not limited to this. For example, if an image pickup section is additionally provided for the recording and reproduction apparatus 5, then the recording and reproduction apparatus 5 can be applied such that it is utilized as a digital still camera. In this instance, an image picked up by the recording and reproduction apparatus 5 is recorded on a disk (for example, the disk 21 of the next generation MD1 or the next generation MD2).

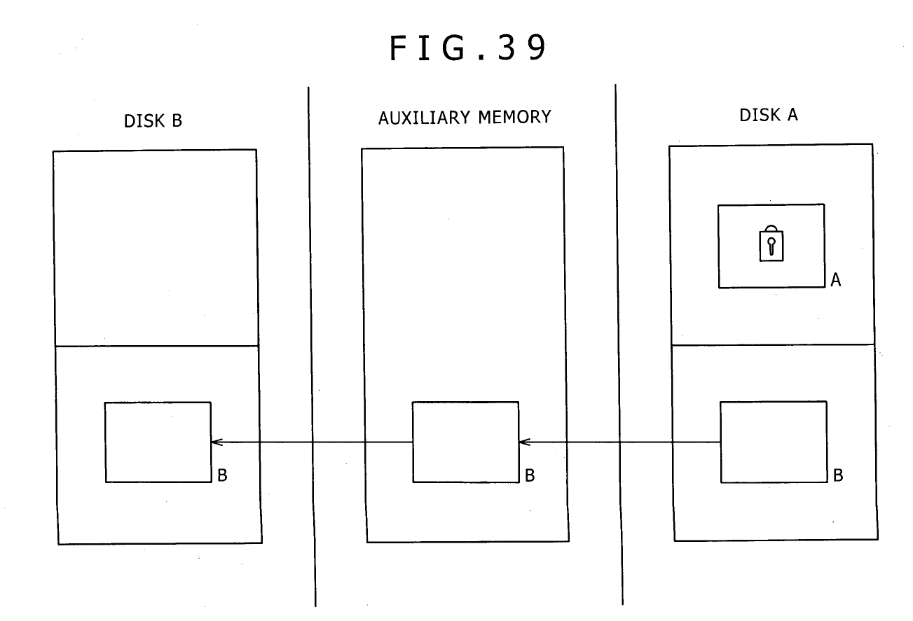

In recent years, the demand to duplicate data of an image picked up by a digital still camera on the spot like extra copying of a photograph and deliver the duplicate to another person has been increasing, and digital still cameras often incorporate an application by which a digital still camera can duplicate data of an image simply. FIG. 39 illustrates an example wherein picked up image data are duplicated and provided. It is assumed now that an image is picked up by the recording and reproduction apparatus 5 and data of the image is recorded as a content B on the disk A.

When data (content B) of an image is duplicated and provided to a different person, the user should execute an application by which data of an image can be duplicated simply so that the content B is duplicated on the disk B owned by the different person. In other words, after the content B is recorded once into the auxiliary memory 105 of the recording and reproduction apparatus 5, the disk A is unloaded and then the disk B is loaded into the recording and reproduction apparatus 5, and then the content B is recorded from the auxiliary memory 105 on the disk B. It is to be noted that, where the content A on the disk A is a secure content, since a secure content cannot be copied in order to protect the copyright but can be only moved, the content A is not recorded into the auxiliary memory 105.

Details of a data copying process where a content is duplicated and passed to a different person is described with reference to flow charts of FIGS. 40 and 41. This process is executed when an application which allows data of an image to be duplicated simply is installed in the recording and reproduction apparatus 5 and the user operates the inputting section not shown to issue an instruction to execute the application based on the substance displayed on the display unit 151.

At step S41, the operation input acceptance section 201 decides whether or not a copying instruction (that is, an instruction to execute the application) is used, and stands by until it decides that a copying instruction is issued.

At step S42, the disk type decision section 202 decides the type of the disk currently loaded in the recording and reproduction apparatus 5. Consequently, it is decided whether the type of the disk is a disk of the existing MD system, a disk of the next generation MD1 or a disk of the next generation MD2.

The decision of the type of the disk is performed, for example, in the following manner. In particular, if a P-TOC in the form of emboss pits is detected in the lead-in region, then it can be decided that the disk is a disk of the existing MD system or of the next generation MD1. Then, if predetermined information such as warning sound is not recorded in the alert track on the outer circumference of the U-TOC, then it can be determined that the disk is of the existing MD system. On the other hand, if control information in the form of an ADIP signal is detected in the lead-in region and a P-TOC in the form of emboss pits is not detected, then it can be decided that the disk is of the next generation MD2.

Alternatively, a rising edge, a falling edge or the like of a servo signal may be discriminated so that only a disk of the next generation MD2 is selectively decided, whereafter a disk of the next generation MD1 is selectively decided based on decision information (for example, a character string of “HIMD” or the like) of a predetermined recording position in the U-TOC.

It is to be noted that the decision method of the type of a disk is not limited to those described above, but it is possible to make the decision of the type of a disk from the phases of a tracking error signal in an on-track state and an off-track state. Naturally, a detection hole for disk identification may be provided alternatively.

At step S43, the disk type decision section 202 decides whether or not the result of the process at step S42 indicates that the disk is of the existing MD system. If it is decided that the disk is not of the existing MD system, or in other words, if it is decided that the currently loaded disk (for example, disk A) is a disk of the next generation MD1 or a disk of the next generation MD2, the processing advances to step S44.

At step S44, the data copying control section 204 acquires the UID of the disk A.

The UID is an identification code unique to each disk as described hereinabove, and in the case of a disk of the next generation MD1, the UID is recorded in the DDT region, and is produced, for example, based on a random number generated in accordance with a predetermined procedure and recorded upon initialization of the disk. In the case of a disk of the next generation MD2, the UID is recorded in a region, which allows reproduction but does not allow recording by means of a recording and reproduction apparatus for consumers, on the inner circumference side of the recordable region using a technique similar to the BCA (Burst Cutting Area) technique used for the DVD (Digital Versatile Disc) upon manufacture of the disk. At step S44, the UID described above is acquired depending upon the type of the disk decided by the process a step S42.

At step S45, the data copying control section 204 selects a content to be copied. At this time, for example, from between the content A and the content B recorded on the disk A, the content B which is a non-secure content is selected as a content to be copied. However, the content to be copied may otherwise be selected based on an instruction of the user. In this instance, however, if the user selects the content A which is a secure content, then the selection is determined to be an error.

At step S46, the data copying control section 204 acquires the content ID of the content to be copied. At this time, for example, the file name of the data file which forms the content B may be acquired as the content ID. Or else, the file name and the file size of the file may be associated with each other to form a content ID to be acquired.

At step S47, the data copying control section 204 produces a table which coordinates the UID of the disk and the content ID with each other.

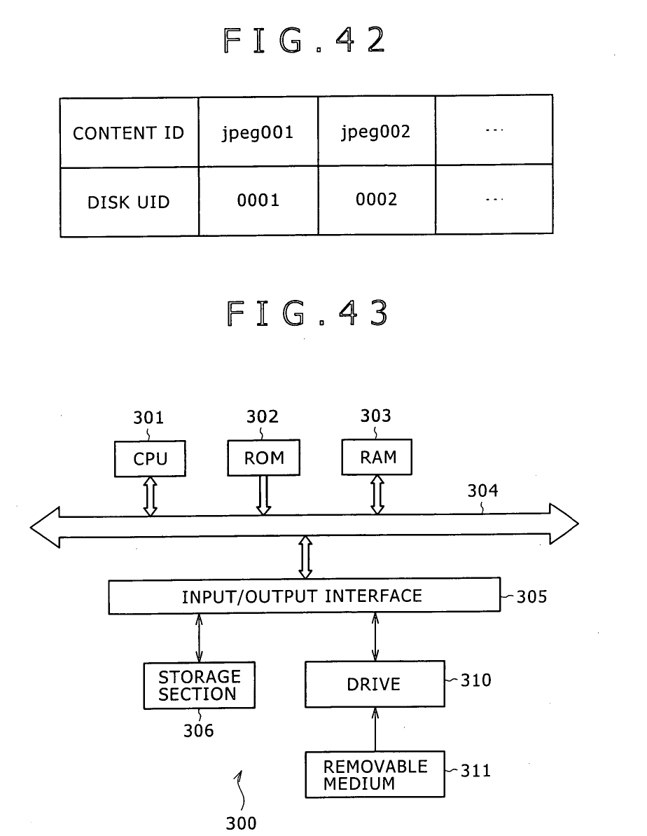

FIG. 42 illustrates an example of the table produced in this instance. Referring to FIG. 42, “jpeg001”, “jpeg002, . . . are recorded as content IDs, and a UID “001” of a disk on which a content coordinated with the content ID “jpeg001” is recorded, another UID “002”, of a disk on which a content coordinated with the content ID “jpeg002” is recorded, . . . are recorded in a coordinated relationship, respectively. At step S47, such a table as illustrated in FIG. 42 is produced and recorded, for example, into a predetermined region in the auxiliary memory 105.

After the process at step S47, the processing advances to step S48, at which the data copying control section 204 copies the content to be copied (in the present case, the content B) into the auxiliary memory 105.

After the process at step S48, the data copying control section 204 decides, at step S49, whether or not the currently loaded disk (in the present case, the disk A) is unloaded from the recording and reproduction apparatus 5, and waits until it is decided that the disk is removed.

If it is decided at step S49 that the disk is removed, then the processing advances to step S51 of FIG. 41, at which the data copying control section 204 decides whether or not a disk is loaded in the recording and reproduction apparatus 5 again, and waits until it is decided that a disk is loaded.

If it is decided at step S51 that a disk is loaded, then the processing advances to step S52, at which the disk type decision section 202 decides the type of the disk currently loaded in the recording and reproduction apparatus 5. Consequently, it is decided whether the type of the disk is a disk of the existing MD system, a disk of the next generation MD1 or a disk of the next generation MD2. The decision of the type of the disk is performed in a similar manner as in the process at step S42.

At step S53, the disk type decision section 202 decides whether or not the result of the decision by the process at step S52 indicates a disk of the existing MD system. If it is decided that the disk is not of the existing MD system, that is, if it is decided that the currently loaded disk is either a disk of the next generation MD1 or a disk of the next generation MD2, then the processing advances to step S54.

At step S54, the data copying control section 204 acquires the UID of the disk. The acquisition of the UID of the disk is performed in a similar manner as in the process at step S44.

At step S55, the data copying control section 204 refers to a table to acquire the UID of the disk coordinated with the content to be copied. At this time, the table produced by the process at step S47 and coordinating the UIDs of disks and contents IDs with each other is referred to, and the UID of the disk coordinated with the content ID of the content B which is a content to be copied is acquired. In the present case, since the content B is recorded on the disk A, the UID of the disk A is acquired.

At step S56, the data copying control section 204 decides whether or not the UID of the disk acquired by the process at step S54 and the UID of the disk acquired by the process at step S55 are same as each other.

For example, where contents are of images picked up by the user itself, which contents are recorded on each disk must be managed by the user itself. However, since disks normally have a same shape and it is difficult to decide a particular disk from the appearance of the disks, there is the possibility that a content may be copied on the same disk in error. Therefore, it is decided at step S56 whether or not the UIDs of the disks are same as each other.

For example, if the user loads the same disk (in the present case, the disk A) again in error (step S51), then since the UID of the disk A is acquired by the process at step S54 and the UID of the disk A is acquired also by the process at step S55, it is decided that the UIDs are same as each other. Consequently, the processing advances to step S58, at which, for example, an error message is outputted to the display unit 151 and it is displayed on the display unit 151 that the same disk is loaded to notify the user.

On the other hand, if it is decided at step S56 that the UID of the dick acquired by the process at step S54 and the UID of the disk acquired by the process at step S55 are not same as each other, then the processing advances to step S57. At step S57, the disk recording execution section 205 copies data of the content (in the present case, the content B) stored in the auxiliary memory 105 on the disk.

For example, if the disk loaded again by the user (step S51) is the disk B, then since the UID of the disk B is acquired by the process at step S54 and the UID of the disk A is acquired by the process at step S55, it is decided at step S56 that the UIDs are not same as each other. Consequently, the processing advances to step S57.

It is to be noted that, if it is decided by the process at step S43 or by the process at step S53 that the currently load disk is a disk of the existing MD system, then the processing advances to step S50 or S59, at which the error process is executed, whereafter the processing is ended.

Data (for example, data of an image picked up by a digital still camera) are copied on a disk in this manner. Consequently, it is possible, for example, to duplicate image (content) on the spot like extra copying of a photograph and pass the image data to a different person through a disk.

Further, since the ID of a content and the UID of a disk are referred to to perform copying, even where it is difficult to distinguish a particular disk from its appearance, such a situation that a content is copied on the same disk in error is prevented. As a result, to the user, the burden of management of contents is moderated and the convenience of the recording and reproduction apparatus 5 is enhanced.

Further, since a non-secure content is selected as a content to be copied into the auxiliary memory 105, such a situation that a secure content is duplicated simply is eliminated. As a result, the copyright of a content can be protected further appropriately.

It is to be noted that, while the series of processes described above can be executed by hardware, it may otherwise be executed by software. Where the series of processes is executed by software, the system controller 109 has a configuration similar to that of such a computer 300 as shown in FIG. 43.

Referring to FIG. 43, a central processing unit (CPU) 301 executes various processes in accordance with a program stored in a ROM (Read Only Memory) 302 or a program loaded from a storage section 306 into a RAM (Random Access Memory) 303. Also data necessary for the CPU 301 to execute the processes are suitably stored into the RAM 303.

The CPU 301, the ROM 302 and the RAM 303 are connected to one another by a bus 304. Also an input/output interface 305 is connected to the bus 304.

Further, a drive 310 (which may be used also as the medium drive section 102) is connected to the input/output interface 305. A removable medium 311 (which may be the disk 21) is suitably loaded into the drive 310, and a computer program read from the removable medium 311 is installed into the storage section 306 as occasion demands.

Where the series of processes described hereinabove is executed by software, a program which constructs the software is installed from a network such as the Internet or a recording medium which may be the removable medium 311.

It is to be noted that, in the present specification, the steps for executing the series of processes described above may be but need not necessarily be processed in a time series in the order as described, and include processes which are executed in parallel or individually without being processed in a time series.

While a preferred embodiment of the present invention has been described using specific terms, such description is for illustrative purpose only, and it is to be understood that changes and variations may be made without departing from the spirit or scope of the following claims.

What is claimed is:

1. A recording and reproduction apparatus for recording data of a content on a disk and reproducing data of a content recorded on the disk, comprising:
a first disk specification information acquisition section for acquiring information which specifies a disk loaded in said recording and reproduction apparatus;
a content specification information acquisition section for acquiring information which specifies a content recorded on the disk;
a table production section for producing a table which coordinates the information, which specifies the disk, acquired by said first disk specification information acquisition section and the information, which specifies the content, acquired by said content specification information acquisition section;
a storage section for storing the content into a memory;
a disk loading decision section for deciding whether or not a disk is newly loaded in said recording and reproduction apparatus;
a second disk specification information acquisition section for acquiring, when it is decided by said disk loading decision section that a disk is newly loaded, information which specifies the newly loaded disk; and
a content copying section for copying the content stored in said storage section on the newly loaded disk or restraining such copying based on the table and the information acquired by said second disk specification information acquisition section and specifying the newly loaded disk.

2. The recording and reproduction apparatus according to claim 1, wherein said content copying section copies the content on the newly loaded disk when the information acquired by said second disk specification information acquisition section and specifying the newly added disk is different from the information specifying the disk and coordinated with the information which specifies the content in the table.

3. The recording and reproduction apparatus according to claim 1, further comprising a disk type decision section for deciding a type of the disk, said storage section or said content copying section storing or copying the content if it is decided by said disk type decision section that the disk is a disk of a predetermined type.

4. The recording and reproduction apparatus according to claim 3, wherein the type of the disk is one of at least
a first disk;
a second disk having a physical attribute same as that of the first disk but having a logical attribute different from that of the first disk, the second disk being suitable for recording of a secure content encrypted in accordance with a predetermined method; and
a third disk having an outer shape similar to that of the first disk but having an increased recording density so as to have an increased recording density when compared with the first disk, the third disk being suitable for recording of the secure content.

5. The recording and reproduction apparatus according to claim 4, wherein said disk type decision section decides that the disk is of the predetermined type if the disk is the second disk or the third disk.

6. The recording and reproduction apparatus according to claim 5, further comprising a content selection section for selecting, from among contents recorded on the disk, those contents other than the secure content, said storage section storing the contents selected by said content selection section into said memory.

7. A recording and reproduction method for a recording and reproduction apparatus for recording data of a content on a disk and reproducing data of a content recorded on the disk, comprising:
a first disk specification information acquisition step of acquiring information which specifies a disk loaded in said recording and reproduction apparatus;
a content specification information acquisition step of acquiring information which specifies a content recorded on the disk;
a table production step of producing a table which coordinates the information, which specifies the disk, acquired by the process at the first disk specification information acquisition step and the information, which specifies the content, acquired by the process at the content specification information acquisition step;
a storage step of storing the content into a memory;
a disk loading decision step of deciding whether or not a disk is newly loaded in said recording and reproduction apparatus;
a second disk specification information acquisition step of acquiring, when it is decided by the process at the disk loading decision step that a disk is newly loaded, information which specifies the newly loaded disk; and
a content copying step of copying the content stored by the process at the storage step on the newly loaded disk or restraining such copying based on the table and the information acquired by the process at the second disk specification information acquisition step and specifying the newly loaded disk.

8. A program for a recording and reproduction apparatus for recording data of a content on a disk and reproducing data of a content recorded on the disk, comprising:
a first disk specification information acquisition controlling step of controlling acquisition of information which specifies a disk loaded in said recording and reproduction apparatus;
a content specification information acquisition controlling step of controlling acquisition of information which specifies a content recorded on the disk;
a table production controlling step of controlling production of a table which coordinates the information, which specifies the disk, acquired by the process at the first disk specification information acquisition controlling step and the information, which specifies the content, acquired by the process at the content specification information acquisition controlling step;
a storage controlling step of controlling storage of the content into a memory;
a disk loading decision controlling step of controlling decision of whether or not a disk is newly loaded in said recording and reproduction apparatus;
a second disk specification information acquisition controlling step of controlling acquisition, when it is decided by the process at the disk loading decision controlling step that a disk is newly loaded, information which specifies the newly loaded disk; and
a content copying controlling step of controlling so as to copy the content stored by the process at the storage step on the newly loaded disk or restrain such copying based on the table and the information acquired by the process at the second disk specification information acquisition step and specifying the newly loaded disk.

9. A recording medium on which a program for a recording and reproduction apparatus for recording data of a content on a disk and reproducing data of a content recorded on the disk is recorded, the program comprising:
a first disk specification information acquisition controlling step of controlling acquisition of information which specifies a disk loaded in said recording and reproduction apparatus;
a content specification information acquisition controlling step of controlling acquisition of information which specifies a content recorded on the disk;
a table production controlling step of controlling production of a table which coordinates the information, which specifies the disk, acquired by the process at the first disk specification information acquisition controlling step and the information, which specifies the content, acquired by the process at the content specification information acquisition controlling step;
a storage controlling step of controlling storage of the content into a memory;
a disk loading decision controlling step of controlling decision of whether or not a disk is newly loaded in said recording and reproduction apparatus;
a second disk specification information acquisition controlling step of controlling acquisition, when it is decided by the process at the disk loading decision controlling step that a disk is newly loaded, information which specifies the newly loaded disk; and
a content copying controlling step of controlling so as to copy the content stored by the process at the storage step on the newly loaded disk or restrain such copying based on the table and the information acquired by the process at the second disk specification information acquisition step and specifying the newly loaded disk.
